(19) United States
(12) Patent Application Publication
(10) Pub. No.: US 2023/0182306 A1
(43) Pub. Date: Jun. 15, 2023

(54) MATERIAL HANDLING SYSTEM AND METHOD THEREFOR

(71) Applicant: Symbotic LLC, Wilmington, MA (US)

(72) Inventors: Kirill Pankratov, Wilmington, MA (US); Ilya Erokhin, Wilmington, MA (US); Oleksandr Muzychko, Wilmington, MA (US); Conner Davis, Wilmington, MA (US)

(21) Appl. No.: 18/063,202

(22) Filed: Feb. 27, 2023

Related U.S. Application Data
(60) Provisional application No. 63/288,253, filed on Dec. 10, 2021.

(51) Int. Cl. B25J 9/16; B65G 57/20

(52) U.S. Cl. CPC B25J 9/1687; B65G 57/20

(57) ABSTRACT

A material handling system, for handling and placing packages onto pallets destined for an order store, including a storage array, an automated package transport system, an automated palletizer, and a controller operably connected to the automated palletizer, the controller being programmed with a pallet load generator with at least one pallet to order store affinity characteristic, for a predetermined method of pallet load packages distribution at the order store, the pallet load generator being configured so that a pallet load is formed by the automated palletizer of packages arranged in the pallet load embodying the at least one pallet to order store affinity characteristic.

### CROSS-REFERENCE TO RELATED APPLICATION

This application claims the benefit of and is a non-provisional of United States Provisional Pat. Application No. 63/288,253 filed on Dec. 10, 2021, the disclosure of which is incorporated herein by reference in its entirety.

### BACKGROUND

### 1. Field

The present disclosure generally relates to material handling systems, and more particularly, to handling and placing goods onto pallets with the material handling system.

### 2. Brief Description of Related Developments

Warehouses or distribution centers for goods generate pallets of goods for various customers, where such customers include but are not limited to retail stores. Each of the various customers order goods, which order is fulfilled by the warehouse or distribution center by loading the ordered goods onto one or more pallets. Each of the various customers may have their own preferred way of depalletizing goods ordered from the warehouse or distribution center to facilitate restocking of those goods on store shelves.

### BRIEF DESCRIPTION OF THE DRAWINGS

The foregoing aspects and other features of the present disclosure are explained in the following description, taken in connection with the accompanying drawings, wherein:

FIG. 1 is an exemplary schematic illustration of a warehouse or distribution center incorporating aspects of the present disclosure;

FIG. 2 is an exemplary a schematic illustration of a pallet load packages distribution in accordance with aspects of the present disclosure;

FIG. 3 is an exemplary a schematic illustration of a pallet load packages distribution in accordance with aspects of the present disclosure;

FIG. 4 is an exemplary a schematic illustration of a pallet load packages distribution in accordance with aspects of the present disclosure;

FIG. 5 is an exemplary a schematic illustration of an order for pallet planning in accordance with aspects of the present disclosure;

FIG. 6 is an exemplary illustration of a pallet-aisle binary matrix in accordance with aspects of the present disclosure;

FIG. 7 is an exemplary method in accordance with aspects of the present disclosure;

FIG. 8 is an exemplary illustration of a planned order in accordance with aspects of the present disclosure;

FIG. 9 is an exemplary illustration of an pallet to aisle selection process in accordance with aspects of the present disclosure;

FIG. 10 is an exemplary illustration of case unit distribution for pallet loads in accordance with aspects of the present disclosure;

FIG. 11 is an exemplary illustration of case unit distribution for pallet loads in accordance with aspects of the present disclosure;

FIGS. 12A and 12B are diagrams of exemplary methods in accordance with aspects of the present disclosure;

FIG. 13 is a diagram of an exemplary method in accordance with aspects of the present disclosure;

FIG. 14 is a diagram of an exemplary method in accordance with aspects of the present disclosure;

FIG. 15 is a diagram of an exemplary method in accordance with aspects of the present disclosure;

FIG. 16 is a diagram of an exemplary method in accordance with aspects of the present disclosure; and

FIG. 17 is a graph illustrating a variation of case dimensions within a representative population of cases.

### DETAILED DESCRIPTION

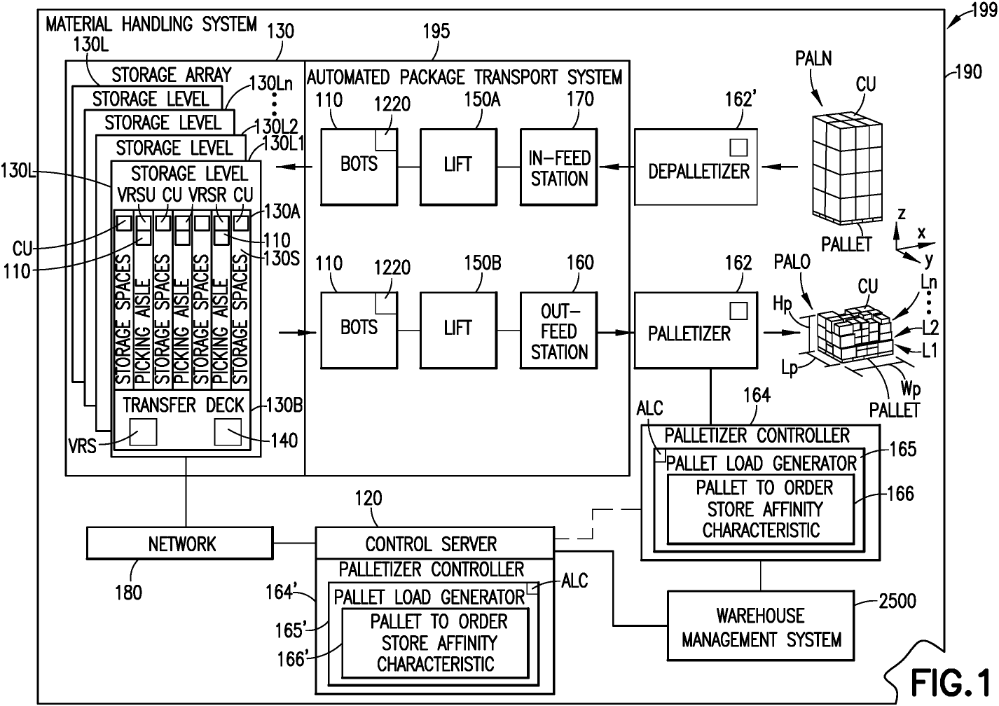

FIG. 1 illustrates an exemplary warehouse or distribution center 199 (generally referred to herein as warehouse 199) in accordance with aspects of the present disclosure. Although the aspects of the present disclosure will be described with reference to the drawings, it should be understood that the aspects of the present disclosure can be embodied in many forms. In addition, any suitable size, shape or type of elements or materials could be used.

The aspects of the present disclosure generally apply to warehouse systems where pallet loads (such as those described herein and which are collectively referred to as pallet load(s) PALO) are built by automated machinery, such as robotized palletizers 162, 162′, according to controller generated pallet plans. However, the aspects of the present disclosure may also be applied to manual pallet building where a pallet load generator (such as described herein) outputs an itemization (in accordance with the present disclosure) of case units CU to be included on a pallet, where a human worker builds the pallet with the predetermined itemized case units CU based on warehouse rules and prior work experience. The aspects of the present disclosure may also be applied to manual warehouses where the pallet plans are computer-generated, in accordance with the present disclosure, and output in a tangible form (e.g., video monitors, graphical user interfaces, smart devices such as phones and tablets, paper instructions, etc.) in an advisory role for human workers to follow so as to build the pallets described herein. Here, the goods included in the pallet loads PALO are delivered to a human worker in a predetermined sequence, inferred from the pallet plans, by conveyors, mobile robots, or other suitable conveyance.

In accordance with the present disclosure, each pallet load PALO is planned with any suitable computational method including, but not limited to, those described in United States Pat. No. 8965559 issued on Feb. 24, 2015 and 9969572 issued on May 15, 2018, the disclosures of which are incorporated herein by reference in their entireties. A “planned pallet” or “planned pallet load” as used herein is a pallet load that has of a list of goods (e.g., individual items, boxes, totes, trays, etc. as described herein and generally referred to as case units CU) with assigned coordinates (X, Y, Z - see FIG. 1) for a corner of the goods that has coordinates closes to the origin (X=0, Y=0, Z=0) of the pallet coordinate system. The orientation of the goods along the X, Y, Z axes has values of, e.g., length, width, height or width, length, height for goods that cannot be tipped on a side. Additional values may be provided for goods that can be placed on a surface on any side of the goods. These additional values include, e.g., length, height, width or width, height, length, or height, length, width, or height, width, length. The pallet plan is a physically valid plan where (1) goods are non-intersecting in physical space, (2) each of the goods is stably supported by other goods or the pallet base, (3) no part of any goods lies outside the predetermined bounds of the pallets outer dimensions Lp, Wp, Hp (or a predetermined volume Vp of the pallet load defined by the outer dimensions Lp, Wp, Hp), and (4) the total weight of goods on a pallet does not exceed a predetermined maximum weight Wmax for the pallet load PALO.

Also in accordance with the present disclosure, a “planned order” is a number list of planned pallets such that all ordered case units CU belong to some pallets in the list and there are no case units CU that do not belong to any pallet load. It is noted that consecutive case units CU in an order list do not have to be assigned to the same or consecutive pallet loads. For example, case unit number 1 may be assigned to pallet load number 5, while case unit number 2 is assigned to pallet load number 3.

It is also noted that the case units CU may have integer values of the “product group types” that the case units CU belong to within a retail store. For example, retail stores generally assign a predetermined relationship between these product group types and the physical locations (e.g., aisles, departments, sections, etc.) within the store at which the products group types are located. As used herein, the product group types and the corresponding physical locations within the retail store are generally referred to as “aisles.” It is noted that the aisles are aisles within a retail store and are not to be confused with (distribution center) storage/picking aisles of the storage array 130 of the (distribution center) material handling system 190. Here, the retail store aisles and the distribution center picking aisles (of the storage array 130) are fully decoupled from one another. It is also noted the retail store aisles are referred to with numerical designations ranging from 1 to n (e.g., aisle 1, aisle 2, ..., aisle n), where n is an integer value denoting a predetermined highest aisle number for a given store. While the aisles may be numbered, the locations of the aisles in the sore may not be sequential. In accordance with the aspects of the present disclosure, case units CU belonging to a common (e.g., the same) aisle (e.g., physical location/aisle and/or product group type) are assigned to a common pallet (unless otherwise noted) for the pallet load packages distribution methods described herein.

In one aspect, aisles in a retail store that are close in number (e.g., such as aisles 34 and 35) may be physically close to one another in space. In this aspect, the present disclosure may optimize the products placed on a given pallet by combining products from physically close aisles (e.g., aisles 34 and 35) on a common pallet, rather than combining products from aisles that are physically separated from each other (e.g., such as aisles 34 and 73).

In other aspects, the relationship between the aisle numbers and spatial proximity of the aisles may be more complex than adjacent aisle numbers (e.g., aisles 34 and 35) being physically adjacent in space. For example, adjacent or close aisle numbers (e.g., aisles 20 and aisle 21) may not mean that the aisles are physically close to each other in space (e.g., aisle 20 may be located on one end of the retail store while aisle 21 may be located on an opposite end of the retail store). Here, a pairwise relationship between two aisles may be provided with respect to the assignment of case units to pallet loads as described herein. For example, in accordance with the aspects of the present disclosure, the pairwise relationship between the two aisles is in the form of coefficients A[i,k] for aisle i and aisle k. This pairwise relationship not only describes the physical proximity between the two aisles, but also retail store preferences to keep products from these aisles on one pallet or separate pallets based on, for example, retail store business logic outside of a distance-based unloading optimization. An example of such business logic may be the separation of caustic products (e.g., laundry detergent) and food items (e.g., baby food) which are preferably transported on separate pallet loads.

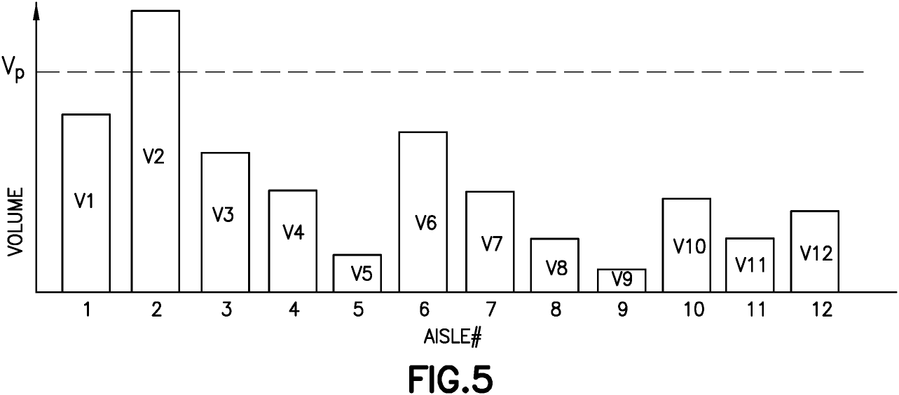

The aspects of the present disclosure are also applicable to any suitable volume of products in any given aisle. For example, some aisles may have a total volume of case units that is much larger than a volume of single pallet (e.g., see volume V2 of aisle 2 in FIG. 5). Here, the aspects of the present disclosure assign the volume of case units to whole pallet loads until a remaining volume of the case units does not fill a whole pallet load. Here, the remaining volume of case units is assigned to a pallet in accordance with the package distribution methods described herein. As another example, a volume of case units for other aisles may be a few case units or even a single case unit, in which case these case units are assigned to a pallet load in accordance with the package distribution methods described herein.

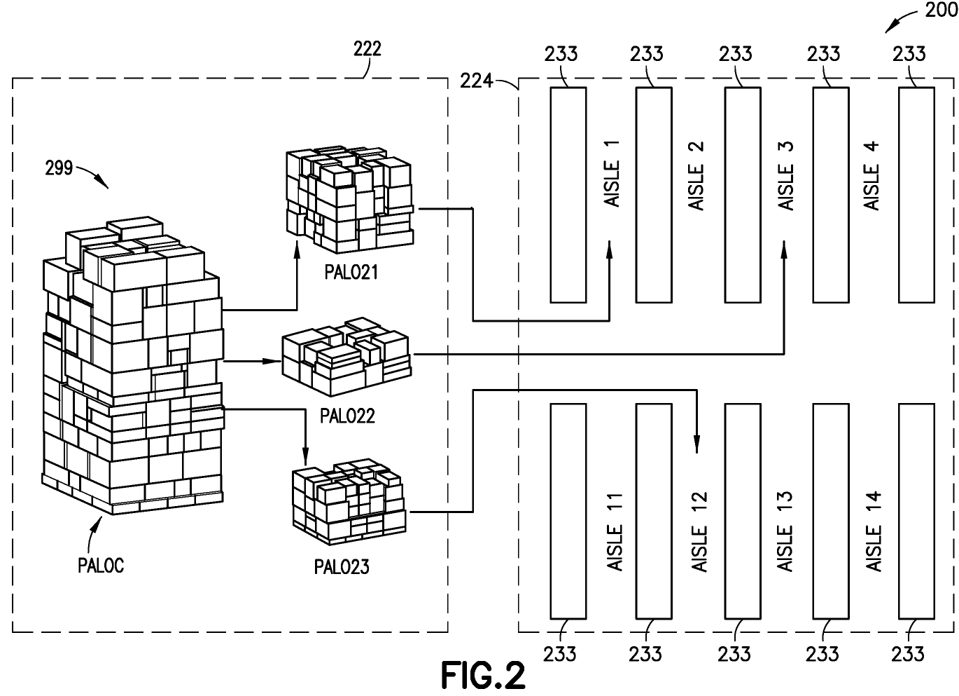

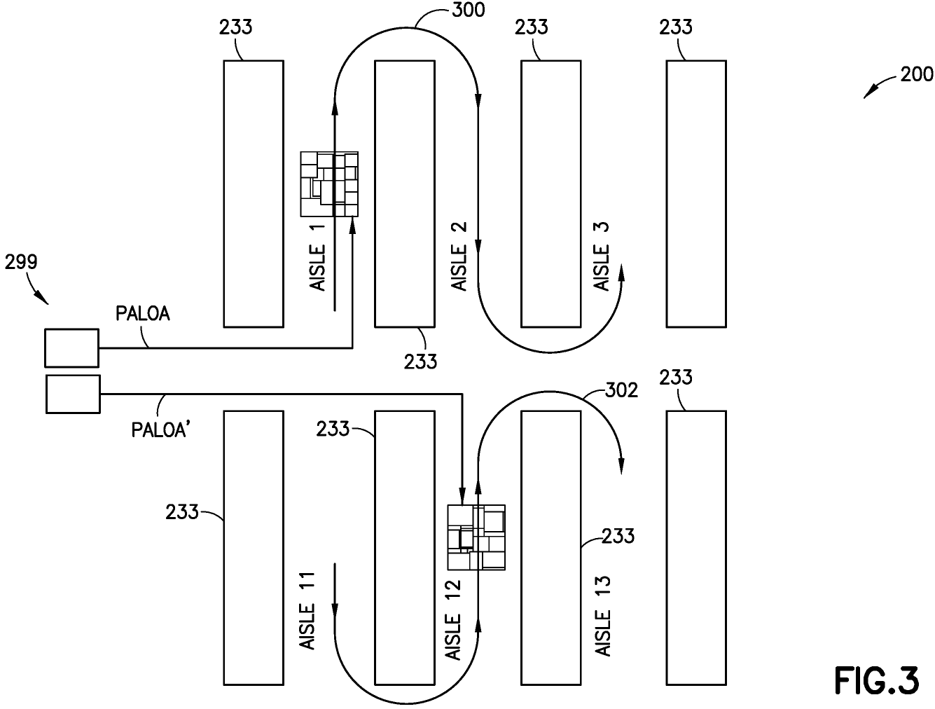

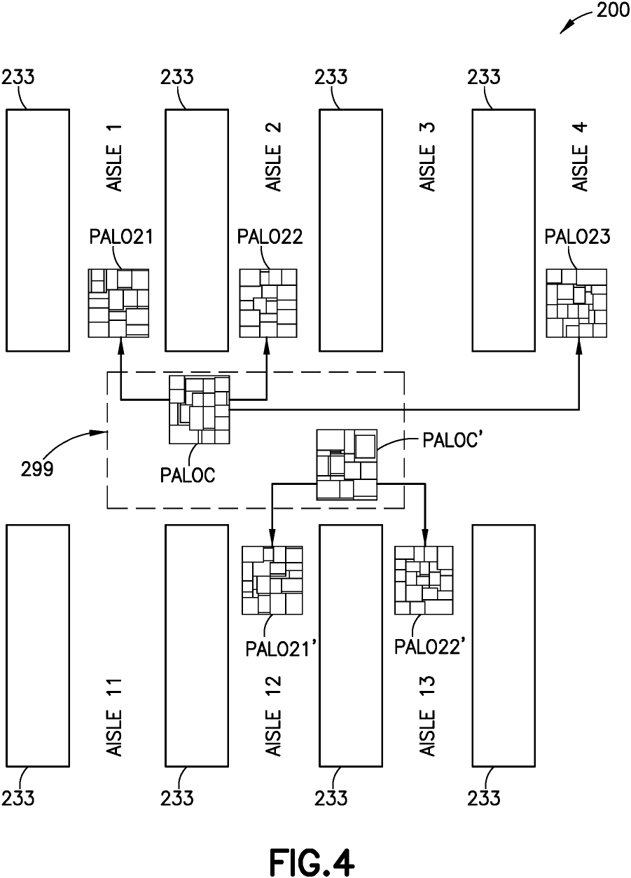

Referring also to FIGS. 2-4, as will be described herein, a material handling system 190 of the warehouse 199 is configured to effect optimization of an automatic process of planning and building mixed-product orders 299 (see, e.g., FIG. 2) that are to be delivered to, for example, retail stores (or other suitable customers to which goods are delivered on pallets). The retail stores placing the orders are referred to herein as order stores 200 (see, e.g., FIGS. 2-4). Each of one or more pallet loads PALO in a mixed-product order 299 is built by the material handling system 190 such that each pallet load PALO is a “store friendly pallet” or “store friendly pallet load.” Here, “store friendly” means the pallet load PALO is configured for easy and efficient unloading and distribution to store shelves. For descriptive purposes only, “store friendly” refers to a store affinity of the pallet load or a pallet load store affinity, such that the pallet load configuration (i.e., the pallet load build) includes a predetermined characteristic (or factor) of store affinity that biases or factors resolution of each pallet load PALO to conform and provide each resultant pallet load PALO with retail store characteristics that are in accordance with or are sympathetic to a retail store predetermined characteristic as will be described herein. For example, when pallet load(s) PALO of a fulfilled mixed-product order 299 (see FIGS. 2-4) arrive at an order store 200, the pallet load(s) PALO (e.g., pallets loads PALOC in FIG. 2, PALOA, PALOA′ in FIG. 3, and PALOC, PALOC′ in FIG. 4) are quickly unloaded (e.g., such as in accordance with “just in time” inventory practices) and the goods thereof are distributed (e.g., restocked/stocked) onto the store shelves 233 with minimal disruption to store operations. To facilitate the quick unloading and distribution of the goods onto the store shelves 233, the material handling system 190 is configured to build the pallet load(s) PALO such that the structure of the goods CU (also referred to herein as packages, products, case units, mixed cases, cases, shipping cases, and shipping units) on the pallet load(s) PALO are grouped in a manner similar to the way the goods CU are distributed onto the store shelves 233.

Each warehouse customer (e.g., order store 200) of the warehouse 199 may have its own preference with respect to the handling of pallet loads within the order store 200. The aspects of the present disclosure provide for the building of store friendly pallets that correspond to the different ways the pallets loads are handled and products are distributed by the warehouse customers.

Referring to FIG. 2, one exemplary way of handling pallet loads PALO may be referred to as a “clustered aisle pallet load packages distribution method” and includes deconstructing/downstacking the pallet load(s) PALOC in a loading dock area 222 (or other suitable area) of an order store and putting goods CU belonging to different sections of the order store 200 onto two or more separate secondary pallets PAL21-PAL23 (three secondary pallets are shown in FIG. 2 for exemplary purposes only) . These secondary pallets PAL21-PAL23 include goods CU assigned to predetermined shopping aisles and are moved into the respective predetermined shopping aisles for unloading (see FIG. 2). With the secondary pallets PAL21-PAL23 in the respective shopping aisle, the goods CU from the secondary pallets PAL21-PAL23 are distributed onto assigned shelves 233.

Referring to FIG. 3, another example of handling pallet loads PALO may be referred to as an “adjacent aisle pallet load packages distribution method” and includes moving whole pallet loads PALOA, PALOA′ (e.g., without downstacking of the pallet) into the shopping aisles. With the pallet loads PALOA, PALOA′ in the shopping aisles, goods CU are distributed substantially directly from the pallet load(s) PALOA, PALOA′ to the assigned shelves 233 (see FIG. 3). Here, the goods are arranged on the pallet load(s) PALOA, PALOA′ so as to minimize a travel distance of each pallet load PALOA, PALOA’ within the store and to substantially avoid a return of the pallets PALOA, PALOA′ to aisles which the corresponding pallets have previously visited (e.g., the pallet passes through an aisle only once along a predetermined path 301, 302). The goods CU may be arranged on the pallet load PALO, PALOA’ according to a path of travel 300, 302 of the respective pallet load PALOA, PALOA’ through the shopping aisles.

Referring to FIG. 4, still another example of handling pallets PALO may be referred to as a “mixed mode clustered and adjacent aisles pallet load packages distribution method” and includes a combination of the above handling methods. With reference to FIG. 4, the pallet loads PALOC, PALOC’ arrive at the order store 200 in trucks (or other suitable conveyance) from the warehouse/distribution center 199. The pallet loads PALOC, PALOC’ are moved (without downstacking the pallets) into the shopping area in a general vicinity of the shelves to which the goods CU on the pallet loads PALOC, PALOC’ are assigned. With the pallet loads PALOC, PALOC’ generally located near the assigned shelves, the pallet loads PALOC, PALOC’ are downstacked into respective secondary pallets PALO21, PALO22, PALO23, PALO21′, PALO22′ that are assigned to respective shopping aisles. Here, the pallet loads PALOC, PALOC’ are built so that each pallet load PALOC, PALOC’ includes goods belonging/assigned to store aisles that are close to one another (e.g., pallet load PALOC includes goods that are located in aisle 1, aisle 2 (which is adjacent to aisle 1), and aisle 4 which is but one aisle away from aisle 2; similarly pallet load PALOC’ includes goods that belong/assigned to adjacent aisles 12 and 13). The goods CU may also be arranged in the respective pallet load PALOC, PALOC’ such that the pallet structure corresponds with the manner in which the goods are downstacked to the respective secondary pallets (e.g., such as a sequential downstacking where, for example, goods assigned to secondary pallet PALO21 are on the top of the pallet structure of pallet load PALOC, goods assigned to secondary pallet PALO22 are in the middle of the pallet structure of pallet load PALOC, and goods assigned to secondary pallet PALO23 are at the bottom of the pallet structure of pallet load PALOC). In this aspect, the aisles to which the goods CU are assigned may not be arranged along a respective specific path (see, e.g., paths 301, 302 in FIG. 3) for unloading goods CU of a respective pallet load PALO, PALO’ onto the store shelves.

The above-described examples of pallet handling/downstacking methods in the order store 200 are exemplary only. It is again noted that the pallet loads PALOC, PALOC’, PALOA, PALOA’ for each of the pallet handling/downstacking methods are generally referred to herein as pallet loads PALO. It is also noted that the pallet load(s) PALO may be built in any suitable manner by the material handling system 190 so that the goods on the pallet load(s) PALO are arranged according to any suitable at least one order pallet to order store affinity characteristic 166, 166′ for the pallet load packages distribution methods described herein. It is noted that the store affinity pallet load resolution (as described herein) is decoupled from the storage array 130 disposition and material handling system 190 throughput of cases CU to the palletizer 162. Here, the output of cases CU from the storage array 130 by the material handling system 190 is selected to conform to or otherwise depends on (is based on) the store affinity pallet load resolution. In one or more aspects, the throughput of cases CU output by the material handling system 190 may be effected in a manner similar to that described in United States Pat. Application No. 17/091,265 filed on Nov. 6, 2020 and titled “Pallet Building System with Flexible Sequencing,” the disclosure of which is incorporated herein by reference in its entirety. In accordance with the aspects of the present disclosure, the case CU disposition within the storage array 130 may be freely optimized for optimum throughput separate from resolution and building of the store affinity pallet load PALO. An example of throughput optimization can be found in United States Pat. No. 9,733,638 issued on Aug. 15, 2017 and titled “Automated Storage and Retrieval System and Control System Thereof,” the disclosure of which is incorporated herein by reference in its entirety.

Referring to FIG. 1, the material handling system 190 may be disposed in a retail distribution center or warehouse 199, for example, to fulfill orders received from retail stores (e.g., order stores 200 - see FIGS. 2-4) for replenishment goods shipped in cases, packages, and or parcels. The terms case, package and parcel are used interchangeably herein and as noted before may be any container that may be used for shipping and may be filled with one or more product units by the producer. Case or cases as used herein means case, package or parcel units not stored in trays, on totes, etc. (e.g. uncontained) . It is noted that the case units CU may include cases of items/unit (e.g. case of soup cans, boxes of cereal, etc.) or individual item/units that are adapted to be taken off of or placed on a pallet. In accordance with the present disclosure, case units (e.g. cartons, barrels, boxes, crates, jugs, shrink wrapped trays or groups or any other suitable device for holding goods) may have variable sizes and may be used to hold goods in shipping and may be configured so they are capable of being palletized for shipping. Case units CU may also include totes, boxes, and/or containers of one or more individual goods, unpacked/decommissioned (generally referred to as breakpack goods) from original packaging and placed into the tote, boxes, and/or containers (collectively referred to as totes) with one or more other individual goods of mixed or common types at an order fill station. It is noted that when, for example, incoming bundles or pallet loads PALN (e.g. from manufacturers or suppliers of case units arrive at the material handling system 190 for replenishment of the goods stored within a storage array 130 of the material handling system 190, the content of each pallet load PALN may be uniform (e.g. each pallet holds a predetermined number of the same item - one pallet holds soup and another pallet holds cereal). As may be realized, the cases of such pallet load PALN load may be substantially similar or in other words, homogenous cases (e.g. similar dimensions), and may have the same SKU (otherwise, as noted before the pallets may be “rainbow” pallets having layers formed of homogeneous cases).

As pallet loads PALO leave the material handling system 190, with cases or totes filling store replenishment orders, the pallet loads PALO may contain any suitable number and combination of different case units (e.g. each pallet may hold different types of case units - a pallet holds a combination of canned soup, cereal, beverage packs, cosmetics and household cleaners). The cases combined onto a single pallet may have different dimensions and/or different SKU’s.

The material handling system 190 generally includes a storage array 130 and an automated package transport system 195. The storage array 130 includes storage spaces 130S for holding case units CU therein. The automated transport system 195 is communicably connected to the storage array 130 for storing case units CU within the storage spaces 130S of the storage array 130 and for retrieving case units CU from the storage spaces 130S of the storage array 130.

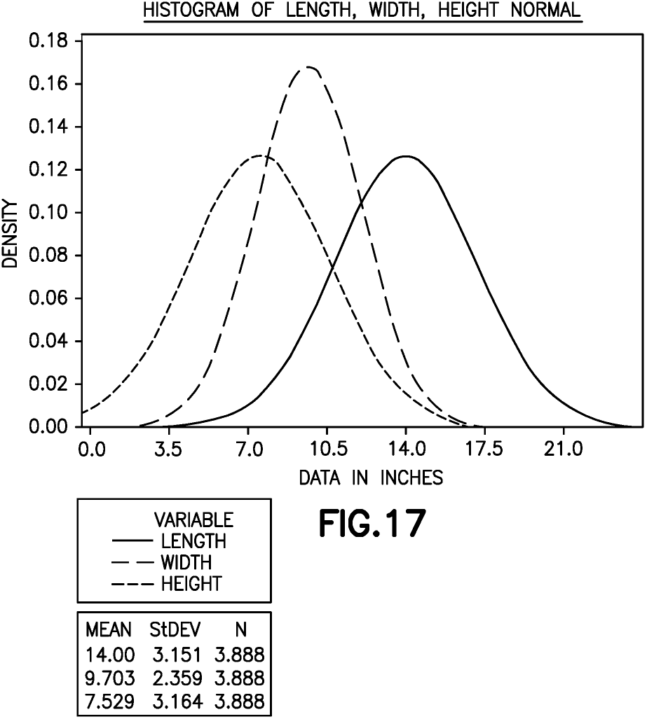

An automated palletizer 162, 162′ includes an automated package pick device 162D (e.g., robot arm, gantry picker, etc.) capable of moving case units CU from a package deposit section (such as out-feed transfer station 160) to a pallet (also referred to herein as a pallet base) to form a pallet load PALO from the case units CU, where the pallet load PALO includes more than one composite layers L1-Ln of case units CU. As described herein, the more than one composite layers L1-Ln of case units CU are formed of case units CU arranged in the pallet load PALO embodying at least one pallet to order store affinity characteristic 166, 166′ for a predetermined method of pallet load packages distribution at an order store 200 (see FIGS. 2-4). The automated palletizer 162, 162′ is communicably connected to the automated package transport system 195. The automated package transport system 195 provides individual case units CU from the storage array 130 to the automated palletizer 162 for forming the pallet load PALO, where the pallet load PALO includes more than one composite layers L1-Ln of case units CU. The individual case units CU from the storage array 130 from which the pallet load PALO is built have a case dimension (e.g., any one or more of a case length, a case width, and a case height), where the case dimension(s) have a substantially Gaussian distribution or a substantially stochastic probability as represented by a normal probability curve as illustrated in FIG. 17. FIG. 17 is a graph illustrating the variation of case dimensions (e.g. length, height and width) within a representative population of cases CU such as may be found in the material handling system 190 and used to generate mixed case pallet loads PALO according to customer replenishment orders (as described herein). As may be realized, the orders may result in mixed case pallet loads PALO including many cases with dimensions from disparate portions of the dimension spectrum illustrated in FIG. 17.

A controller 164, 164′ is operably connected to the automated palletizer 164. The controller 164, 164′ is programmed with non-transitory computer program code defining a pallet load generator 165, 165′ with at least one pallet to order store affinity characteristic 166, 166′ (as will be described herein), for a predetermined method of pallet load PALO case unit CU distribution at the order store 200. As described herein, the pallet load generator 166, 166′ is configured so that the pallet load PALO is formed by the automated palletizer 162 of case units CU arranged in the pallet load PALO embodying the at least one pallet to order store affinity characteristic 166, 166′.

In greater detail now, and with reference still to FIG. 1, the material handling system 190 may be configured for installation in, for example, existing warehouse structures or adapted to new warehouse structures. As noted before the material handling system 190 shown in FIG. 1 is representative and may include for example, in-feed and out-feed conveyors (e.g., transferring case units from and to the respective depalletizer 162′ and palletizer 162) terminating on respective in-feed and out-feed transfer stations 170, 160, lift module(s) 150A, 150B, a storage array 130 (e.g., including suitable structure such as racks, vehicle riding surfaces, storage shelves, etc.), and a number of autonomous transport vehicles 110 (also referred to herein as “bots”).

It is noted that the material handling system 190 is formed at least by the storage array 130 and the bots 110. In some aspects the lift modules 150A, 150B also form part of the material handling system 190; however in other aspects the lift modules 150A, 150B may form vertical sequencers in addition to the material handling system as described in United States Pat. Application No. 17/091,265 filed on Nov. 6, 2020 and titled “Pallet Building System with Flexible Sequencing,” the disclosure of which is incorporated herein by reference in its entirety). In alternate aspects, the material handling system 190 may also include robot or bot transfer stations 140 that may provide an interface between the bots 110 and the lift module(s) 150A, 150B.

The storage array 130 includes any suitable structure that forms multiple (stacked) storage levels 130L1-130Ln (see FIG. 1, generally referred to as storage levels 130L or a storage level 130L, and where n is an integer that denotes an upper number of storage levels present in the material handling system 190) of storage rack modules where each level 130L includes respective picking aisles 130A, storage spaces 130S, and transfer decks 130B for transferring case units between any of the storage spaces 130S of the storage structure 130 and a shelf of the lift module(s) 150A, 150B. The storage spaces 130S are arranged along (or alongside) one or more sides of each picking aisles 130A so that bots 110 travelling along a picking aisle 130A have access to the storage spaces 130S on either side of the picking aisle 130A.

The picking aisles 130A are in one aspect configured to provide guided travel of the bots 110 (such as along a vehicle riding surface VRSR that includes bot guiding features such as rails) while in other aspects the picking aisles are configured to provide unrestrained travel of the bot 110 (e.g., along a vehicle riding surface VRSU that is open and undeterministic with respect to bot 110 guidance/travel). The transfer decks 130B have open and undeterministic bot support travel surfaces VRS along which the bots 110 travel under guidance and control provided by bot steering (e.g., such steering being effected by one or more of differential drive wheel steering, steerable wheels, etc.). In one or more aspects, the transfer decks 130B have multiple lanes between which the bots 110 freely transition for accessing the picking aisles 130A and/or lift modules 150A, 150B. The picking aisles 130A, and transfer decks 130B also allow the bots 110 to place case units CU into picking stock and to retrieve ordered case units CU. In alternate aspects, each storage level 130L may also include respective bot transfer stations 140 that provide a case unit transfer interface between the bots 110 and the lift module(s) 150A, 150B.

The bots 110 may be configured to place case units CU, such as the above described retail merchandise, into picking stock in the one or more levels 130L of the storage array 130 and then selectively retrieve ordered case units CU for shipping the ordered case units CU to, for example, an order store 200 (see, e.g., FIGS. 2-4) or other suitable location.

The in-feed transfer stations 170 and out-feed transfer stations 160 may operate together with their respective lift module(s) 150A, 150B for bi-directionally transferring case units CU to and from one or more levels 130L of the storage structure 130. It is noted that while the lift modules 150A, 150B may be described as being dedicated inbound lift modules 150A and outbound lift modules 150B, in alternate aspects each of the lift modules 150A, 150B may be used for both inbound and outbound transfer of case units from the material handling system 190. Similarly, while the palletizers 162, 162′ may be described as being dedicated (inbound) depalletizers 162′ and (outbound) palletizers 162, in alternate aspects, each of the palletizers 162, 162′ may be used for both inbound and outbound transfer of case units from the material handling system 190.

As may be realized, the material handling system 190 may include multiple in-feed and out-feed lift modules 150A, 150B that are accessible by, for example, bots 110 of the material handling system 190 so that one or more case unit(s), uncontained (e.g. case unit(s) are not held in trays), or contained (within a tray or tote) can be transferred from a lift module 150A, 150B to each storage space 130S on a respective level 130L and from each storage space 130S to any one of the lift modules 150A, 150B on the respective level 130L. The bots 110 may be configured to transfer the case units between the storage spaces 130S (e.g., located in the picking aisles 130A or other suitable storage space/case unit buffer disposed along the transfer deck 130B) and the lift modules 150A, 150B. Generally, the lift modules 150A, 150B include at least one movable payload support that may move the case unit(s) between the in-feed and out-feed transfer stations 160, 170 and the respective level 130L of the storage space 130S where the case unit(s) CU is stored and retrieved. The lift module(s) may have any suitable configuration, such as for example reciprocating lift, or any other suitable configuration. The lift module(s) 150A, 150B include any suitable controller (such as controller 120 or other suitable controller coupled to controller 120, warehouse management system 2500, and/or palletizer controller 164, 164′) and may form a sequencer or sorter in a manner similar to that described in United States Pat. Application No. 16/444,592 filed on Jun. 18, 2019 and titled “Vertical Sequencer for Product Order Fulfillment” (the disclosure of which is incorporated herein by reference in its entirety).

The material handling system 190 may include a control system, comprising for example one or more control servers 120 that are communicably connected to the in-feed and out-feed conveyors and transfer stations 170, 160, the lift modules 150A, 150B, and the bots 110 via a suitable communication and control network 180. The communication and control network 180 may have any suitable architecture, which, for example, may incorporate various programmable logic controllers (PLC) such as for commanding the operations of the in-feed and out-feed conveyors and transfer stations 170, 160, the lift modules 150A, 150B, and other suitable system automation. The control server 120 may include high-level programming that effects a case management system (CMS) managing the case flow through the material handling system 190.

The network 180 may further include suitable communication for effecting a bi-directional interface with the bots 110. For example, the bots 110 may include an on-board processor/controller 1220. The network 180 may include a suitable bi-directional communication suite enabling the bot controller 1220 to request or receive commands from the control server 120 for effecting desired transport (e.g. placing into storage locations or retrieving from storage locations) of case units CU and to send desired bot 110 information and data including bot 110 ephemeris, status and other desired data, to the control server 120.

As seen in FIG. 1, the control server 120 may be further connected to a warehouse management system 2500 for providing, for example, inventory management, and customer order fulfillment information to the CMS 120 level program. A suitable example of a material handling system arranged for holding and storing case units is described in U.S. Pat. No. 9,096,375, issued on Aug. 4, 2015 the disclosure of which is incorporated by reference herein in its entirety.

Referring to FIGS. 1-5, building pallet loads PALO in accordance with at least one pallet to order store affinity characteristic will be described in greater detail with respect to the aspects of the present disclosure. As noted above, the at least one pallet to order store affinity characteristic 166, 166′ is at least one (e.g., a predetermined customer affinity) for the clustered aisle pallet load packages distribution method (see, e.g., FIG. 2), the adjacent aisles pallet load package distribution method (see, e.g., FIG. 3), and the mixed mode clustered and adjacent aisles pallet load packages method (see, e.g., FIG. 4). The at least one pallet to order store affinity characteristic 166, 166′ may be stored in any suitable memory, such as a memory of the control server 120 and/or palletizer 162, 162′ as described herein, and employed by the control server 120 and/or palletizer 162, 162′ for generating the pallet loads PALO described herein. The term aisle as used hereinafter refers to, unless otherwise noted, an order store aisle for which the pallet load PALO is destined.

Referring to FIGS. 1 and 5, an exemplary graph for a sample order for pallet planning (see FIG. 5) is illustrated and includes case units from one or more aisles of the order store 200 (FIGS. 2-4). In the exemplary sample order shown in FIG. 5 the aisles are numbered 1-12. A total volume V1-V12 of case units CU ordered for each respective aisle 1-12 is represented by a height of the respective bar in the graph (each bar corresponding to a respective aisle 1-12). The volumes V1-V12 are illustrated as fractional units relative to an expected total volume Vp of case units CU on a full pallet load (e.g., the full pallet load having maximum pallet load dimensions in length Lp, width Wp, and height Hp). The volume Vp is a product of the maximum dimensions Lp (length), Wp (width), Hp (height) (e.g., of the space allocated for case units CU on the pallet load), multiplied by the expected volumetric efficiency E of packing products on the pallet load, where:

$$\text{Vp = Lp} ∗ \text{Wp} ∗ \text{Hp} ∗ \text{E}$$

Generally, the dimensions (e.g., length, width, height) of the goods/case units CU are known where the case units CU have a general cuboid shape. Here, the known dimensions of the case units provide for the determination of the total volume Vp of case units CU (e.g., a combined volume of the case units CU assigned to any one given pallet load). As an example, and depending on the computational method for planning individual pallet loads, the average total product volume on a pallet is statistically about 0.8 with a standard deviation of 0.03 of a volume of the outer bounds of a pallet load having the dimensions Lp (length) x Wp (width) x Hp (height) (e.g., about 80% of the pallet volume is occupied by goods, while the rest is empty space between the goods). The expected efficiency E depends on the packing algorithms of the computational method (such as those described herein), which for state-of-the-art packing algorithms (such as those of the computational methods described herein) and mixed products, containing boxes of a variety of dimensions, should generally exceed the value of about 0.8.

Generally referring to FIG. 5, it can be seen that some of the aisles 1-12 (see, e.g., aisle 2) may have a total volume (such as volume V2 of aisle 2) that exceeds an expected (e.g., maximum) volume Vp of one pallet load PALO. Other aisles 1-12 may have respective volumes that are small or smaller than (see volume V9 of aisle 9) compared to the expected total volume Vp. As described herein, in accordance with the aspects of the present disclosure, the pallet load generator 165, 165′ (e.g., of the control server 120 and/or palletizer 162, 162′) is configured to resolve the pallet load PALO in accordance with at least one pallet to order store affinity characteristic 166, 166′ so that the pallet load PALO is one or more of:
maximized with respect to at least one of a maximum pallet load volume Vp and a maximum pallet load weight Wmax,
has a maximum number of packages from a minimum number of store aisles,
generated to have a minimum number of pallet loads for each store order,
generated so that, for each pallet load destined for the order store 200, the case units CU forming the pallet load represent a minimum number of order store aisles, and
generated so that, for each pallet load destined for an order store 200, the resolved pallet load represents a minimum number of order store aisles.

With reference to FIGS. 1, 2, 5, 6, 7, 8, and 12, the pallet to order store affinity characteristic 166, 166′ for the clustered aisle pallet load packages distribution method will be described in greater detail. The clustered aisle pallet load packages distribution method minimizes both of (1) the number of pallets created from a given set of products and (2) an average pallets-per-aisle ratio RPA. The pallets-per-aisle ratio RPA is determined as a total count of instances of products from each aisle on each pallet, divided by the total number of aisles. The pallets-per-aisle ratio RPA may be understood as the number of times the pallet load PALO will be present in any aisle, or the number of aisles in which the pallet load PALO is present to unload. This number is sought to be minimized (e.g., brought towards 1).

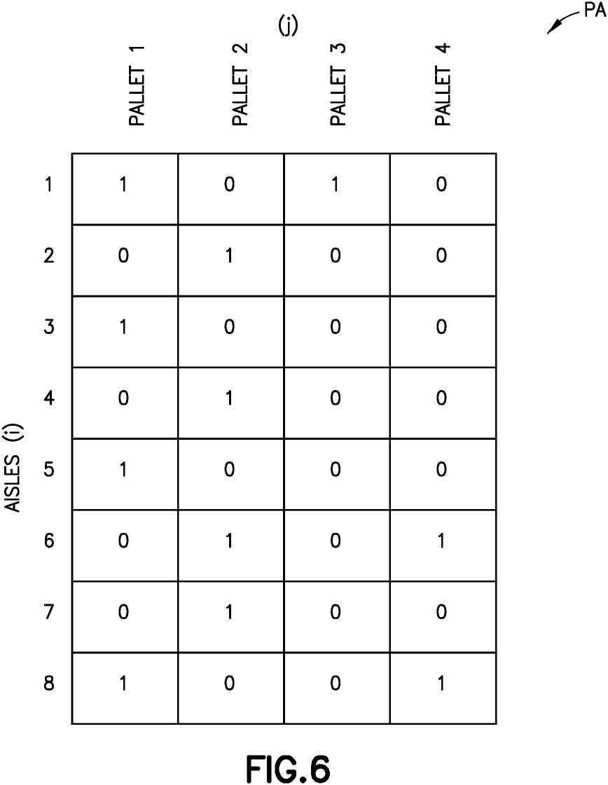

The pallets-per-aisle ratio RPA may be represented by a pallet-aisle binary matrix PA as illustrated in FIG. 6. Here the pallet-aisle binary matrix PA has the number of rows equal to the number of aisles (eight aisles are illustrated for exemplary purposes) and the number of columns equal to the number of pallets (four pallets are illustrated for exemplary purposes) planned for a given order. If a product from the aisle (i) is present in the pallet (j), then the element of the pallet-aisle binary matrix PA[i,j] at the row (i) and the column (j) is equal to 1, otherwise the element of the pallet-aisle binary matrix PA[i,j] at the row (i) and the column (j) is equal to 0. The pallets-per-aisle ratio RPA is determined as the sum of all elements of the pallet-aisle binary matrix PA divided by the number of aisles with products present in the order. It is noted that if every aisle is present only in one pallet, then the pallets-per-aisle ratio RPA is equal to 1. The pallets-per-aisle ratio RPA is higher with more products from some aisles scattered across several pallets. Where products from every aisle are present in every pallet, then the pallets-per-aisle ratio RPA is equal to the number of pallets. In the example illustrated in FIG. 6, the pallets-per-aisle ratio RPA is equal to 11/8 or 1.375. Here, the pallets-per-aisle ratio RPA is greater than 1 because the products from aisle 1 are present in pallets 1 and 3, products from aisle 6 are present in pallets 2 and 4, and products from aisle 8 are present in pallets 1 and 4.

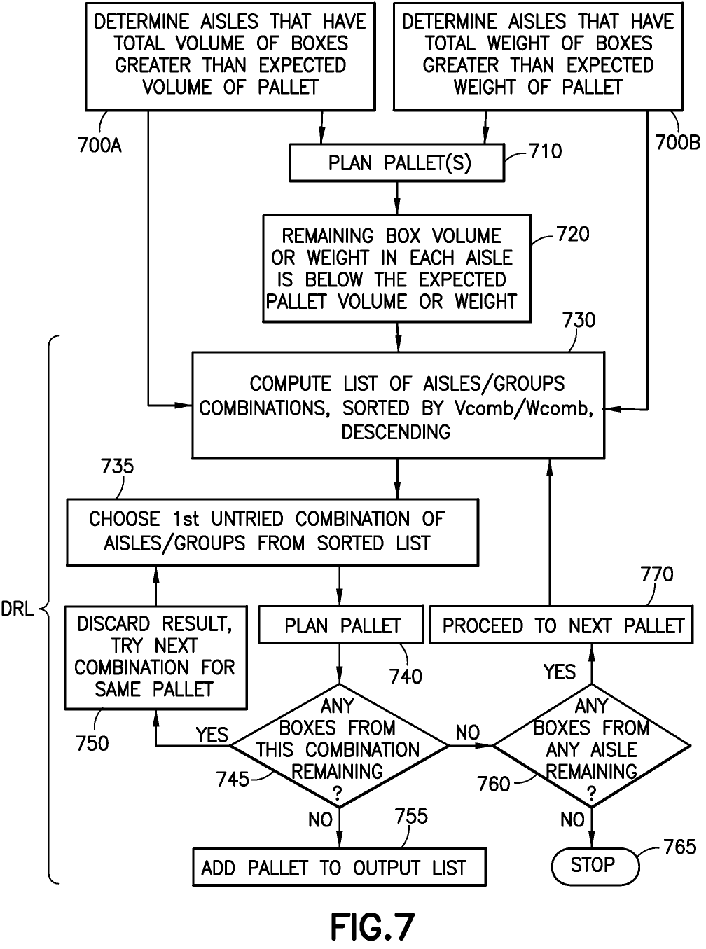

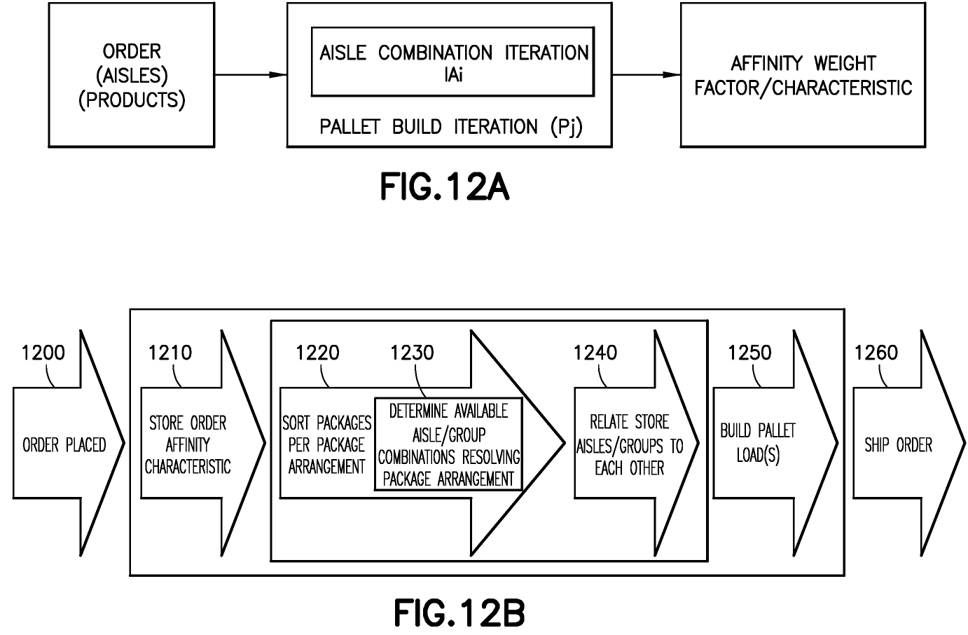

In the clustered aisle pallet load packages distribution method all single-aisle pallets are planned for aisles with a volume of case units CU exceeding an expected pallet volume Vp or maximum pallet weight Wmax as will be described in greater detail herein. Remaining pallets for filling a store order are planned from combinations of aisles where such planning employs a repeating dual loop determination, such as illustrated in FIG. 12A where for each aisle combination iteration IAi (e.g., nested within the broader pallet build iteration Pj), a pallet is planned such that the volume Vc(IAi) is maximized with respect to the expected pallet volume Vp (e.g., so as to minimize a number of pallets in the order) and the pallets-per-aisle ratio RPA is minimized (e.g., so as to approach 1). Here, the repeating dual loop determination iterates through combinations of aisles until a pallet being planned is planned successfully (as described in greater detail below) and iterates through pallets until a whole store order is consumed (e.g., the order is filled) and there are no more case units CU in the store order that are unplanned (i.e., not assigned to a pallet load). Here, the order store affinity characteristic 166, 166′ is informed by the repeating dual loop determination where at least one loop of which relates order store aisles to each other. At least the other loop of the repeating dual loop determination determines available combinations of order store aisles resolving arrangement of case units or packages CU in a given pallet load PALO. The repeating dual loop determination is illustrated in, for example, FIGS. 7 and 12B and will be described below with respect to a pallet load build in accordance with the order store affinity characteristic for the clustered aisle pallet load packages distribution method.

The warehouse management server 2500 or the control system 120 (or any other suitable controller of the warehouse 199) receives a store order (FIG. 12B, Block 1200). Where, the warehouse management server 2500 receives the store order, the store order is conveyed to the control server 120 through the network 180 or in any other suitable manner. The control server 120 commands the automated package transport system 195 to retrieve the ordered goods from the storage array 130 for transport to the palletizer 162. For example, the bots 110 on one or more predetermined storage levels 130L1-130Ln are commanded by the control server 120 to retrieve ordered case units CU from predetermined storage spaces 130S of the respective storage level 130L1-130Ln. The bots transport the retrieved case units CU from the storage spaces 130S to the lift(s) 150B so that the retrieved case units CU are output through the out-feed transfer station 160 in a predetermined order to the palletizer. Here, the predetermined order of case unit CU output is determined at least in part by order store affinity characteristic 166, 166′.

One or more of the control server 120 and palletizer 162 is/are configured to determine the pallet to order store affinity characteristic 166, 166′ (FIG. 12B, Block 1210) based on, for example, the order store 200 that places the order. For example, a palletizer controller 164, 164′ of one or more of the control server 120 and the palletizer 162 is configured with a pallet load generator 165, 165′. For example, in one aspect, each respective order store 200 may inform the pallet load generator 165, 165 of the respective pallet to order store affinity characteristic 166, 166′ prior to placement of the order (such as when the order store opens an account with the warehouse 199, or at any other suitable time, and the pallet to order store affinity characteristic 166, 166′ is communicated or entered into the warehouse management system). Here, the pallet load generator 166, 166′ may include any suitable table that relates each order store 200 with the respective pallet to order store affinity characteristic 166, 166′. In other aspects, the pallet to order store affinity characteristic 166, 166′ may be communicated to the pallet load generator 165, 165′ coincident with placing the order (such as an entry in the order submission, where the pallet load generator determines the pallet to order store affinity characteristic 166, 166′ substantially directly from the order regardless of an identity of the order store 200). As noted above, in this example the pallet to order store affinity characteristic 166, 166′ is for the clustered aisle pallet load packages distribution method.

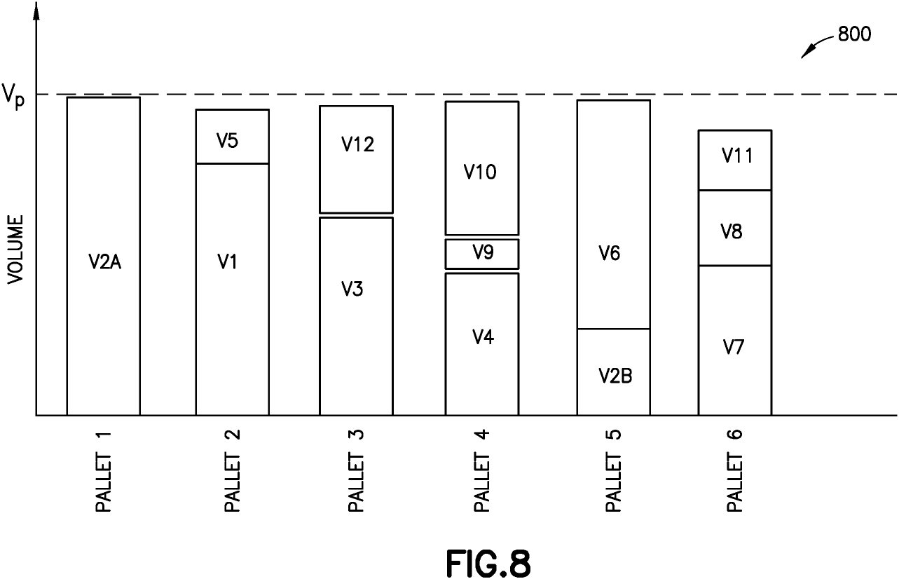

The pallet load generator 165, 165′ determines any aisles that have a total volume of case units Vcomb that is greater than the expected volume Vp of a pallet load PALO (FIG. 7 Block 700A) (in the example illustrated in FIG. 5, aisle 2 has a volume V2 that is greater than the expected volume Vp). Alternatively, the pallet load generator 165, 165′ determines any aisles that have a total weight of case units Wcomb that is greater than an expected weight Wmax (e.g., a maximum weight) of a pallet load PALO. Based on the presence of any aisles with a total volume of case units Vcomb that is greater than the expected volume Vp or a total weight of case units Wcomb greater than the expected weight Wmax (referred to collectively herein as the “aisles-in-excess”), the pallet load generator 165, 165′ plans pallet loads PALO formed entirely with case units ordered for and belonging to the aisles-in-excess (FIG. 7, Block 710). In some aspects, there will be some case units CU remaining from the aisles-in-excess (FIG. 7, Block 720), which remaining case units are included in subsequent pallet loads. For example, the pallet load generator 165, 165′ forms pallet load 1 (see FIG. 8) with a portion V2A of the case unit volume V2 from FIG. 5, while a remaining portion V2B of the case unit volume V2 from FIG. 5 is included in pallet load 5 as will be described below.

The subsequent pallet loads (or pallet loads where there are no aisles-in-excess) are planned from one store aisle or combinations of more than one store aisle. As described herein, the aisle combinations are created computationally, by the pallet load generator 165, 165′, so as to minimize the pallet-per-aisle ratio and maximize the case unit volume of each pallet load PALO. Here, each of the available aisle combinations of the order store aisles is determined based on a maximization of the pallet load or, in other aspects as described herein, a combined maximization of the pallet load and a contiguity or adjacency of aisles in the available combination, where the maximization of the pallet load is weighted higher than the contiguity or adjacency of the aisles.

Each of the subsequent pallet loads have a total volume of case units Vcomb that is less than the expected product volume Vp of the pallet load PALO, and a total weight of case units Wcomb that is less than the expected weight Wmax of the pallet load PALO. Each of the combinations of aisles may have different numbers of aisles ranging from one aisle to a total number of aisles remaining in the order. A list of allowed aisle combinations ALC (see FIG. 1) may be determined (FIG. 7, Block 730) by employing a binary representation of an integer iterator, where the integer iterator has a value k that ranges from 1 to 2^{Na}-1, where Na is the number of aisles remaining in the order. Each increment of this integer iterator corresponds to a potential aisle combination as follows: If the m^{th} bit from the least significant bit of the binary representation of the integer iterator is 1, then the aisle m from the remaining list of aisles is present in the combination, and if the least significant bit is 0, then the aisle m is absent from the combination.

As an example of employment of the integer iterator, assume a store order that has 5 aisles (there may be more or less than five aisles) and the integer iterator is equal to 12, i.e., the twelfth iteration (noting that eleven iterations of a possible 31 iterations occurred prior to the twelfth iteration (where for this example the integer iterator ranges from 1 to 31 as determined by k = 2^{Na}-1 = 2⁵-1 = 31 iterators/iterations), and that there may be subsequent iterations after the twelfth iteration such as where aisles remain in the order). The binary representation of the number 12 (i.e., the integer iterator) is 01100. The number of aisles, arranged in an order from highest to lowest, may be arranged in a grid relative to the binary representation of the integer iterator (so that the numbers of the aisles align with a corresponding number in the binary representation of the integer iterator) as follows:

| | | | | | |
|---|---|---|---|---|---|
| Aisle Number | 5 | 4 | 3 | 2 | 1 |
| Bit values of integer iterator | 0 | 1 | 1 | 0 | 0 |

As noted above, where a bit of the integer iterator corresponding to an aisle is 1 then case units CU from that aisle are present in the combination of aisles. In the example provided above, the bits of the integer iterator corresponding to aisles 4 and 3 are 1, meaning that case units CU from aisles 4 and 3 are included in the 12^{th} iterative combination of aisles while aisles 5, 2, and 1 are excluded from the 12^{th} iterative combination of aisles.

For each value k of the integer iterator, the total volume Vcomb and weight Wcomb of case units CU in the corresponding aisle (e.g., the respective aisle combination for a given value k of the integer iterator) is determined and compared, by the pallet load generator 165, 165′, with the expected pallet volume Vp and maximum pallet weight Wmax. If any of the values of Vcomb and Wcomb exceed the values of Vp and Wmax respectively, the aisle combinations having at least one of Vcomb and Wcomb values exceeding the values of Vp and Wmax are discarded. If both of the values of Vcomb and Wcomb are less than the values of Vp and Wmax respectively, the aisle combinations having both Vcomb and Wcomb values less the values of Vp and Wmax are added to the list of allowed aisle combinations ALC. Referring to the example above, the combined volumes V3 and V4 of aisles 3 and 4, respectively, must be less than or equal to the expected pallet volume Vp and the combined weights W3 and W4 of aisles 3 and 4, respectively, must be less than or equal to the maximum pallet weight Wmax in order to be included in the list of allowed aisle combinations ALC.

The list of allowed aisle combinations ALC may be sorted in any suitable manner, such as in descending order of the total (case unit) volume Vcomb of each of the aisle combinations. Sorting the list of allowed aisle combinations in descending order of total case volume Vcomb may provide for building the fewest number of pallets for a given store order. Here, the list of allowed aisle combinations ALC serves as a list of candidate combinations of products selected to plan a pallet load PALO in an output pallet list for a given store order.

An exemplary sorted list of allowed aisle combinations ALC of ten aisles may be presented as follows:

| | | |
|---|---|---|
| Aisle combination 1 | Aisles 2, 3, 8 | Vcomb/Vp = 0.99 |
| Aisle combination 2 | Aisles 1, 4, 6, 9 | Vcomb/Vp = 0.98 |
| Aisle combination 3 | Aisles 3, 7 | Vcomb/Vp = 0.98 |
| Aisle combination 4 | Aisles 4, 5, 10 | Vcomb/Vp = 0.96 |

where the right-most column represents a total volume ratio of case units of the respective aisles in the aisle combination (e.g., the combined volume Vcomb) relative to the expected pallet volume Vp.

It is noted that in aspects where the number of aisles included in a store order is large, each aisle may be subdivided into any suitable number of aisle subdivisions, where a size of the aisle subdivisions may depend on computational resources of the pallet load generator 165, 165′. The size of the aisle subdivisions may also effect a least number of pallets generated/output by the warehouse 199 for a given store order. The aisle subdivisions may be grouped with other aisle subdivisions to form store partitions in which each aisle subdivision is treated as an aisle and the list of aisle combinations ALC is determined in the manner described above for each of the store partitions.

As noted above the pallet to order store affinity characteristic for the clustered aisles pallet load packages distribution method is informed by a repeating dual loop DRL determination where at least one loop of which determines available combinations of order store aisles resolving arrangement of packages in the pallet load and another at least one loop of which relates order store aisles to each other. In the repeating dual loop DRL pallet loads are planned by employing the list of aisle combinations ALC.

In one loop of the repeating dual loop DRL, the pallet load generator 165, 165′ determines available aisle combinations resolving package arrangement in a pallet load (FIG. 12B, Block 1230). An entry from the list of aisle combinations ALC having the highest Vcomb/Vp ratio (which in the example above is aisle combination 1) is chosen (FIG. 7, Block 735) and a pallet load PALO is planned with the case units CU corresponding to the aisles in the chosen aisle combination (FIG. 7, Block 740), thus effecting an optimization with respect to the minimum number of pallets. Where a pallet plan for the chosen aisle combination does not fit all case units from the aisles in the chosen aisle combination in the pallet load PALO (which means that some of the case units of the corresponding aisles remain unpacked for inclusion in other pallets, confirming or verifying optimization of the pallet-per-aisle ratio RPA - FIG. 7, Block 745), the pallet plan is discarded (FIG. 7, Block 750). A next entry from the list of aisle combinations ALC having the next highest Vcomb/Vp ratio (e.g., the next aisle combination, which in the example above is the aisle combination 2) is chosen (FIG. 7, Block 735), thus again effecting an optimization with respect to the minimum number of pallets. A pallet load PALO is planned with the case units CU corresponding to the aisles in the next aisle combination (FIG. 7, Block 740), where Blocks 740, 745, 750, 735 are repeated (for subsequent aisle combinations, e.g., aisle combination 2, aisle combination 3, aisle combination 4, and so on) until a pallet plan for a chosen entry from the list of aisle combinations ALC succeeds in packing all case units for the corresponding aisles in the pallet load (e.g., the pallet load PALO), again confirming or verifying optimization of the pallet-per-aisle ratio RPA. Here, the aisle combinations are analyzed by the pallet load generator 165, 165′ in sequence, via a repeating dual loop DRL determination, with respect to pallet planning until a planning solution is found that will include all case units ordered for the aisles in the aisle combination.

As an example of the sequential analyzation of the aisle combinations, using the aisle combinations 1-4 above, the pallet load generator 165, 165′ first analyzes aisle combination 1 (aisles 2, 3, 8) to determine whether all ordered case units CU for aisles 2, 3, and 8 will fit in one pallet load having the maximum volume Vp and maximum weight Wmax. For exemplary purposes assume that not all ordered case units for aisles 2, 3, and 8 will fit in one pallet load, and as such the next aisle combination in the aisle combination sequence (e.g., aisle combination 2) is analyzed. Here, the pallet load generator 165, 165′ analyzes aisle combination 2 (aisles 1, 4, 6, and 9) to determine whether all ordered case units CU for aisles 1, 4, 6, and 9 will fit in one pallet load having the maximum volume Vp and maximum weight Wmax. For exemplary purposes assume that all ordered case units for aisles 1, 4, 6, and 9 will fit in one pallet load, and as such the determination loop sequentially analyzing the aisle combination is stopped and the remaining aisle combinations (e.g., aisle combinations 3 and 4) are not analyzed. Any subsequent pallet load, as described below, will be generated with an updated set of aisle combinations (that is separate and distinct from the previous set of aisle combinations and that excludes the aisles for which all ordered case units have been assigned to a pallet load).

The successful pallet plan (which in the above example is aisle combination 2) forms the planned pallet load PALO and is added to an output list (FIG. 7, Block 755) that is executed by the automated package transport system 195 such that the automated package transport system 195 picks and sorts the case units CU in the planned pallet load PALO (FIG. 12B, Block 1220) for building of the planned pallet load at the palletizer 162 (FIG. 12B, Block 1250). In some aspects, case unit picking and pallet building for a given store order may occur substantially simultaneously with the planning of subsequent pallet loads in that store order, while in other aspects, case unit picking and pallet building may occur after all pallets are planned for the store order.

In another loop of the repeating dual loop DRL, where a planned pallet load PALO is successfully planned, the pallet load generator 165, 165 determines if there are any case units CU from any aisle in the store order that have not been included in a (successfully) planned pallet load PALO (FIG. 7, Block 760). Where there are no more case units CU, the pallet planning is stopped (FIG. 7, Block 765) and the case units CU of the planned pallet loads PALO for the store order are retrieved from storage and sorted by the automated package transport system 195 (FIG. 12B, Block 1220) and the pallet loads PALO are built (FIG. 12B, Block 1250) by the palletizer 162. Where case units CU remain, another (e.g., subsequent) pallet is planned for inclusion in the store order (FIG. 7, Block 770). Here, the pallet load generator 165, 165′ updates the relationships between the store aisles (FIG. 12B, Block 1240; FIG. 7, Block 730) such that all combinations of aisles containing any aisle fully consumed by previous pallets (e.g., aisles for which all ordered case units have already been assigned to a pallet load) are removed and an updated list of aisle combinations ALC is generated (FIG. 7, Block 730). The repeating dual loop DRL continues until there are no case units CU left unplanned for any aisle of the store order (i.e., all ordered case units are assigned to a pallet load). The pallet load generator 165, 165′ is configured to relate each store aisle to each other (FIG. 12B, Block 1240, see also FIG. 7, Block 730 described herein) to one or more of minimize the total number of pallet loads in the order and minimize the pallet-per-aisle ratio RPA. It is noted, as described herein, the term “aisle” as used herein generally denotes both an order store aisle and a product group to which an integer value is assigned. As such, the order store aisles (e.g., physical location in the order store) are related to each other by at least one of an aisle to aisle affinity characteristic and a product group type to product group type affinity characteristic.

FIG. 8 is an exemplary store order 800 planned with the pallet load generator 165, 165′ employing the clustered aisle pallet load packages distribution method described above. In this exemplary order 800, the volume of case units in each aisle illustrated in FIG. 5 are shown included in the respective pallet loads (e.g., pallet 1-pallet 6), where each pallet load is sequentially planned (as described above) so as to have a volume Vcomb that is less than the maximum pallet volume Vp. As can be seen in FIG. 8, the volume V2 corresponding to case units CU ordered for aisle 2 is divided (as described above) among pallet loads 1 and 5 such that pallet load 1 is fully consumed by case units ordered for aisle 2. It is noted that the last planned pallet load (e.g., pallet load 6) may have a combined volume Vcomb that is smaller than the previously planned pallet loads (e.g., pallet loads 1-5) because the last pallet load includes case units for aisles that were not included in the previous aisle combinations for previously planned pallet loads 1-5, which previously planned pallet loads were optimized for volume or weight, effecting an optimization of the minimum number of pallets and/or an optimization of the pallet-per-aisle ratio RPA.

In accordance with the clustered aisle pallet load packages distribution method, the generated pallet load(s) PALO are built by the palletizer 162 and shipped (FIG. 12B, Block 1260) to the order store 200. The pallet load(s) PALO arrive at the order store 200 from the warehouse 199. Referring to FIG. 2, the pallet load(s) PALO are generally received in a loading dock area 222 of the order store 200. Each of the pallet load(s) PALO includes products from several physical locations (e.g., aisles, departments, sections, etc.) of the order store 200. For exemplary purposes, these physical locations will be referred to herein as aisles. It is noted that while aisles 1-4 and aisles 11-14 are illustrated in FIG. 2, the order store may have any suitable number of aisles. In the clustered aisle pallet load packages distribution method the case units CU stored on a pallet load PALO are unloaded (e.g., manually or with automation, such as an automated depalletizer similar to those described herein with respect to palletizers 162, 162′) from the pallet load PALO onto separate and distinct secondary pallet loads PALO21, PALO22, PALO23 (three are shown for exemplary purposes and it should be understood that there may be more or less than three secondary pallet loads). Here, each of the secondary pallet loads PALO21, PALO22, PALO23 includes case units CU from separate single aisles. For example, pallet load PALO21 includes only case units CU assigned to aisle 1, pallet load PALO22 includes only case units CU assigned to aisle 3, and pallet load PALO 23 includes only case units CU assigned to aisle 12. The secondary pallets PALO21, PALO22, PALO23 are moved (e.g., manually and/or with an automated conveyance) from the loading dock area 222 to the respective assigned aisle in the shopping area 224 of the order store 200 where the case units CU of the respective secondary pallet load PALO21, PALO22, PALO23 are unloaded and placed on the respective store shelf 233 of the respective assigned aisle.

In the clustered aisle pallet load packages distribution method, the pallet load PALO may hold case units CU assigned to aisles that are located spatially distant (e.g., far) from one another in the order store 200. As described above, unloading of the case units CU assigned to a respective aisle onto a respective secondary pallet load PALO21, PALO22, PALO23 is such that the pallet load PALO holding case units CU assigned to aisles that are located spatially distant (e.g., far) from one another has substantially little to no impact on the restocking/stocking of the store shelves 233. Here, in the clustered aisle pallet load packages distribution method, case units CU from different aisles may be assigned to a common pallet load PALO (regardless of aisle proximity) to maximize the number of full-size pallet loads (e.g., pallet loads having the maximum pallet load dimensions and/or weight), and to minimize the number of pallet loads PALO on a conveyance that moves the pallet loads PALO from the warehouse 199 to the order store 200.

Referring now to FIGS. 1, 4, 5, 9, 12, and 13, the pallet to order store affinity characteristic for the mixed mode clustered and adjacent aisles pallet load packages distribution method will be described in greater detail. The mixed mode clustered and adjacent aisles pallet load packages distribution method minimizes both of (1) the number of pallets created from a given set of products and (2) an average pallets-per-aisle ratio RPA, while minimizing a distance between shelf locations of case units assigned to each pallet. For purposes of description, aisle numbers that are numerically close to each other are also spatially close to each other (e.g., aisles 10 and 11 are near one another while aisle 60 is far from both aisles 10 and 11). Here the above-described clustered aisle pallet load packages distribution method is modified so that pallet loads are planned (e.g., based on a contiguity or adjacency of one order store aisle to another order store aisle) where, in the order store 200, products on a common pallet are unloaded into aisles that are contiguous or adjacent one another.

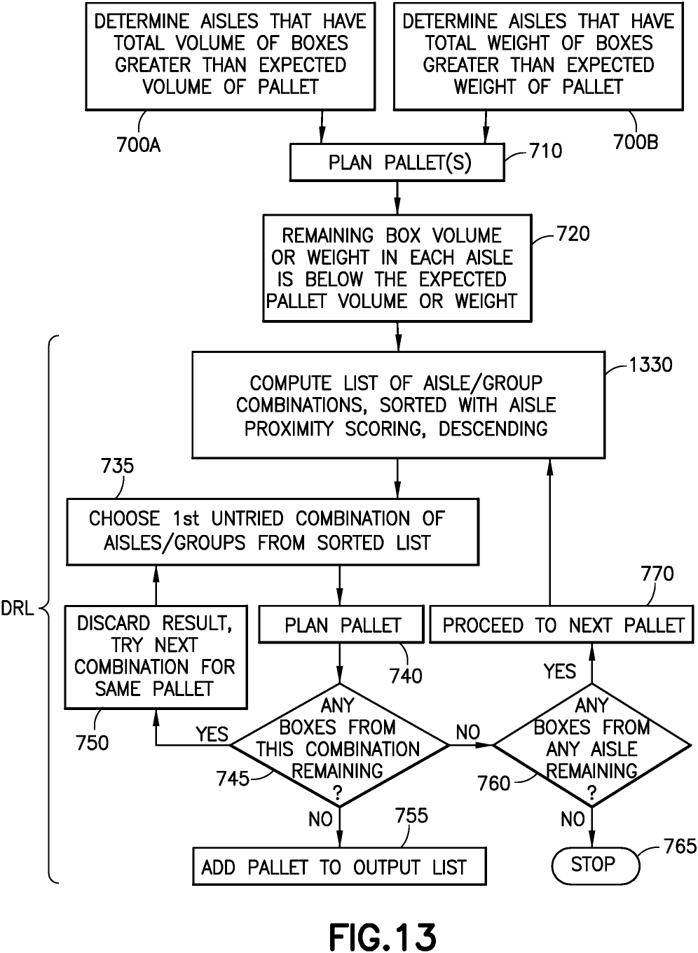

In the mixed mode clustered and adjacent aisles pallet load packages distribution method orders are placed by the order store 200 and the at least one store order affinity characteristic is determined in the manner described above with respect to FIG. 12B, Blocks 1200 and 1210. Blocks 700A, 700B, 710, 720 of FIG. 13 are the same as the similarly numbered blocks in FIG. 7 described above. As such, whole pallets are planned from aisles with case unit volumes that are greater than the pallet load volume Vp and/or weights that are greater than the maximum pallet load weight Wmax, where the remaining case units ordered for those aisles are included in the aisle combination analysis (FIG. 13, Blocks 700A, 700B, 710, and 720) in the manner described above. The aisle combinations for the mixed mode clustered and adjacent aisles pallet load packages distribution method are also determined in the manner described above with respect to FIG. 7, Block 730 (see also FIG. 12B, Block 1220); however, the determined aisle combinations are sorted by a score S that accounts for the volume of the ordered case units for a given aisle, the weight of the ordered case units for a given aisle, and the closeness of aisles included in a planned pallet (FIG. 13, Block 1330). For example, the score S may be determined by the following equation:

$$S = \frac{\left(\frac{V c o m b}{V p}\right)}{\left(d 0 + m a x A i s l e - m i n A i s l e\right)}$$

where minAisle and maxAisle are the smallest and largest aisle numbers included in a given aisle combination, and d0 is greater than 0 and is a parameter reflecting the relative importance of aisle spread/distance (e.g., store friendliness) versus the volume of case units in a pallet load. As can be seen from equation 2, for a small values of d0, the aisle spread/distance is more important than the volume of case units in a pallet load, and for large values of d0 the volume of case units the volume of cases in a pallet load is more important than the spread/distance between aisles assigned to the pallet load. The determined aisle combinations (see FIG. 7, block 730) are weighted or scored with the score S and are sorted based on the score S (FIG. 13, Block 1330). The repeating dual loop DRL is performed for planning pallets in the manner described above with respect to FIG. 7, Blocks 735, 740, 745, 750, 755, 760, 765, 770 (see also FIG. 12B, Block 1230) so as to effect optimization with respect to the minimum number of pallets and verify/confirm optimization of the pallet-per-aisle ratio RPA; however, for each subsequent pallet the updated aisle combinations are again scored with the score S and sorted based on the score S. The ordered case units are picked and the planned pallet loads PALO are built and shipped to the order store in the manner described above with respect to FIG. 12B, Blocks 1240, 1250, and 1260.

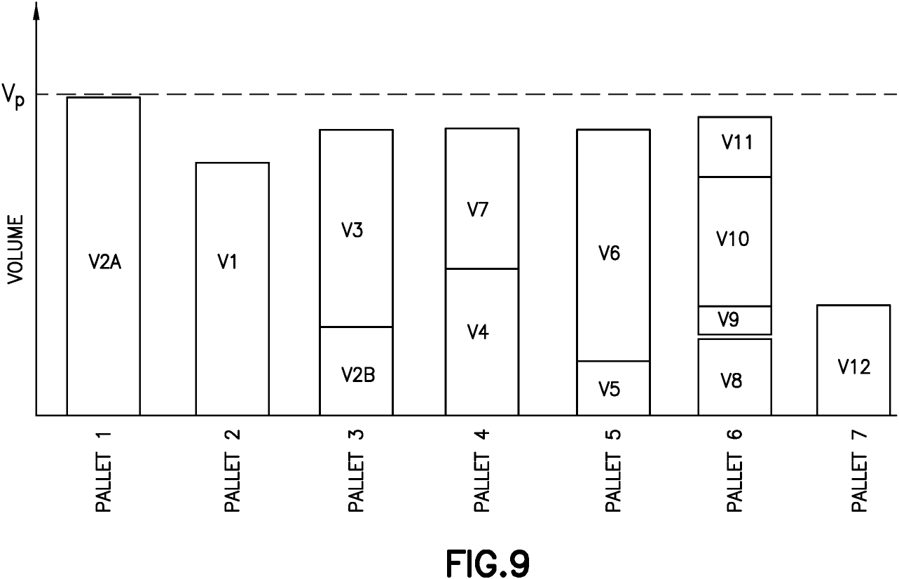

FIG. 9 is an illustrative example of planned pallet loads (e.g., pallet 1 - pallet 7) determined with the mixed mode clustered and adjacent aisles pallet load packages distribution method. In this illustrative example, the planned pallet loads are determined from an order having the aisles and respective case unit volumes illustrated in FIG. 2. As can be seen in FIG. 9, the first pallet load is planned from the portion of case unit volume V2A from aisle 2 alone and all other planned pallet loads in the store order have a volume Vcomb that is less than the expected volume Vp of a pallet load (as described above). In accordance with the mixed mode clustered and adjacent aisles pallet load packages distribution method, planned pallet load 1 includes only the volume of case units V1 assigned to aisle 1. Planned pallet loads 2 includes the volume of case units V2B and V3 assigned to aisles 2 and 3. Planned pallet load 4 includes the volume of case units V4 and V7 assigned to aisles 4 and 7, noting that planned pallet load 4 produces a break in a sequence of aisles, but this break is not a large one as aisle 4 is but 3 aisle away from aisle 7, which conforms with the object of the mixed mode clustered and adjacent aisles pallet load packages distribution method. The planned pallet load 5 includes the volumes of case units V5 and V6 assigned to aisles 5 and 6. The planned pallet load 6 includes the volumes of case units V8-V11 assigned to aisles 8-11. The planned pallet load 7 includes the volume of case units V12 assigned to aisle 12.

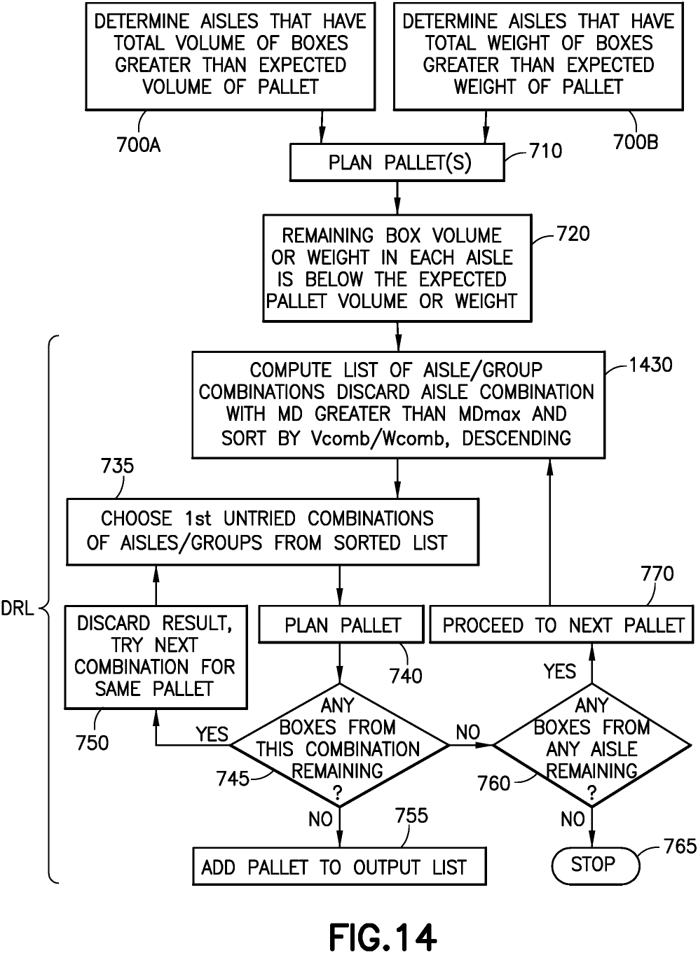

Referring also to FIG. 14, in some aspects of the mixed mode clustered and adjacent aisles pallet load packages distribution method, a maximum (or average) distance MDmax, generally expressed in terms of a difference between aisle numbers, between aisles for ordered case units CU assigned to any given pallet may be specified by an order store 200. This aspect of the mixed mode clustered and adjacent aisles pallet load packages distribution method is the same as that described above; however, aisle combinations that include aisles having a distance between aisles greater than the maximum distance MDmax are excluded/discarded prior to sorting the list of aisle combinations (see FIG. 14, Block 1430).

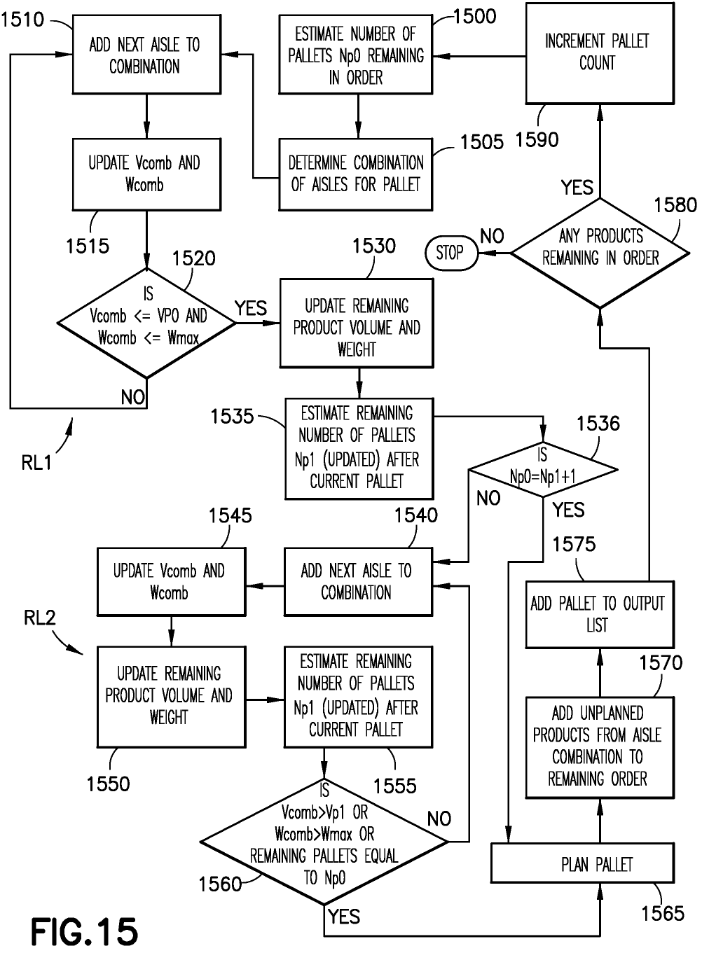

As described herein with respect to FIG. 15, in other aspects of the mixed mode clustered and adjacent aisles pallet load packages distribution method, a pair-wise relationship between aisles p and q may be specified by an order store 200. The relationship between the aisles p and q may be expressed as an aisle affinity matrix A[p,q], where p and q belong to a set of all aisles present in an order. The aisle affinity matrix A[p,q] is diagonally symmetric so that A[p,q] is equal to A[q,p]. The values of the aisle affinity matrix A[p,q] should be substantially equal to, or close to, 1 for “store friendly” aisles such that case units CU for these aisles should be on a same (e.g., single) pallet load. The values of the aisle affinity matrix A[p,q] should be substantially equal to, or close to, 0 for “unfriendly” aisles the case units CU of which aisles should be kept apart in different pallet loads (as mentioned above, e.g., the separation of caustic products (e.g., laundry detergent) and food items (e.g., baby food)). The diagonal elements of the aisle affinity matrix A[p,q] should be equal to 1, e.g., A[p,p]=1 for each p, with the implication that any aisle is friendly with itself.

Employing the pair-wise relationship between aisles, the mixed mode clustered and adjacent aisles pallet load packages distribution method remains as described above; however, the score S is modified as shown in the following equation:

$$S = \left(\frac{V c o m b}{V p}\right) + p ∗ m e a n \left(A \left[p , q\right]\right)$$

for all {p,q} belonging to a given combination of aisles. In equation 3, the expression p is greater than or equal to 0 and is a multiplier that shows the relative importance of pallet volumes (e.g., minimization of the total number of pallets) and friendliness between aisles included in a given combination of aisles. For smaller values of p, aisle friendliness is less important compared to the minimization of the total number of pallets; while for larger values of p friendliness is more importance compared to the minimization of the total number of pallets. In the manner described above (see FIG. 13), the determined aisle combinations are scored and sorted in a descending order according to the scoring, and starting from the first aisle combination in the sorted list of aisle combinations, a pallet load is planned for each sequential aisle combination until a successful pallet load is planned, again optimizing the minimum number of pallets and verifying/confirming optimization of the pallet-per-aisle ratio RPA.

Referring to FIGS. 1, 3, 5, 10, 11, 12, and 15, the pallet to order store affinity characteristic for the adjacent aisles pallet load packages distribution method will be described in greater detail. The adjacent aisles pallet load packages distribution method of pallet planning may be employed for warehouse customers that transport ordered pallets to the store aisles for unloading the case units from the ordered pallets directly to the store shelves. Here, as can be seen in FIG. 3, each ordered pallet load PALOA, POLOA′ is transported from one aisle to another along respective transport paths 300, 302 for unloading the case units. The transport paths 300, 302 travel through the aisles in a contiguous sequence of aisles (e.g., pallet load PALOA travels through contiguous aisles 1-3 and pallet load POLOA′ travels through contiguous aisles 11-13).

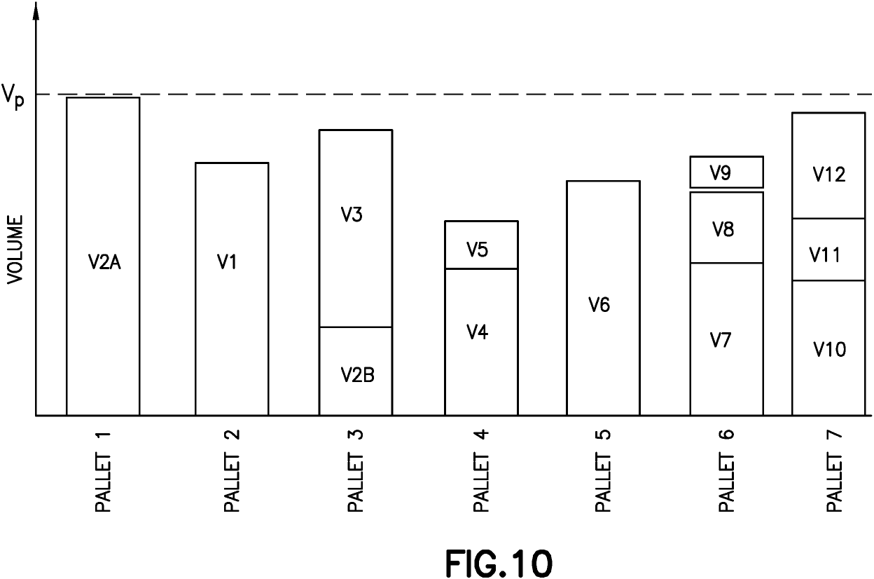

In the adjacent aisles pallet load packages distribution method the selection of contiguous or adjacent aisles is prioritized when planning a pallet load, while the total number of pallets planned for any given order is minimized and excessive splitting of aisles between pallets is substantially avoided. Where aisles are split between two pallets, no more than one aisle is split between the two pallets. An exemplary illustration of pallet loads planned with a “pure” adjacent aisles pallet load packages distribution method is shown in FIG. 10. As with the other pallet load packages distribution methods, aisles having a volume greater than the predetermined volume Vp of a pallet load (or a weight greater than the maximum weight Wmax of a pallet load) are selected and assigned to a full/whole pallet (see FIG. 5 where aisle 2 has a volume V2 greater than the volume Vp of a pallet load) until the volume or weight remaining in the respective aisle is less than the volume Vp or weight Wmax. As can be seen in FIG. 10, pallet load 1 is fully consumed by a portion V2A of the volume V2 of aisle 2. As described herein, with full pallet loads planned from the aisles-in-excess, all remaining volumes and weights of the aisles in the order (e.g., volumes and weights of the case units ordered for each respective aisle) are less than volume Vp and weight Wmax of a pallet load. As such, each aisle has a case units quantity that is expected to fit in a single pallet load and in many instances combined with other case units from other aisles in a single pallet load effecting minimization of the number of pallets and the pallets-per-aisle ratio RPA.

In the adjacent aisles pallet load packages distribution method the total number of pallet loads in the order and the pallet-per-aisle ratio RPA are minimized, but to a lesser extent compared to assigning case units CU to pallets in contiguous/adjacent aisle sequences (e.g., each of the available combinations of order store aisles is determined based more on a contiguity or adjacency of the order store aisles in an available combination and less on a maximization (either volume or weight) of the pallet load. When planning the pallet loads according to the adjacent aisles pallet load packages distribution method, some aisles can be split between pallets, but only when avoiding splits generates additional pallets, thereby increasing the overall number of pallets planned for any given order.

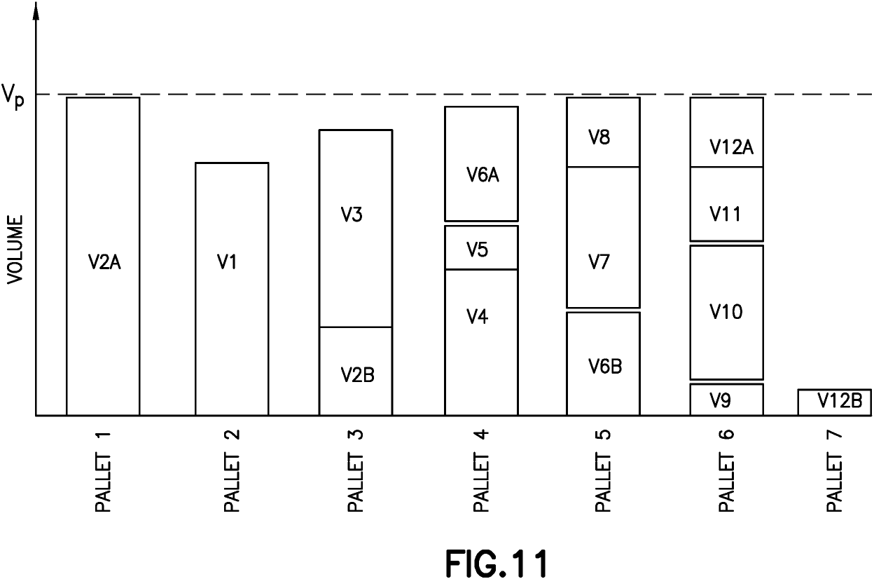

If splitting of the aisle between pallet loads is not allowed, the total number of pallets may increase. For example FIG. 11 illustrates a store order (e.g., such as illustrated in FIG. 2) planned with the adjacent aisles pallet load packages distribution method without splitting case units from an aisle between pallet loads (with the exception of any aisles-in-excess, such as aisle 2, where a portion of the case units for each aisle-in-excess is consumed by a whole pallet load and the remainder of case units are distributed among the remaining pallet loads in accordance with the adjacent aisles pallet load packages distribution method). In FIG. 11, the resulting order plan includes seven pallet loads, which is the same number of pallet loads as the mixed mode clustered and adjacent aisles pallet load packages distribution method, but is one more pallet load than that of the clustered aisle pallet load packages distribution method (noting the examples of which distribution methods are based on the case unit order for the aisles shown in FIG. 5). It is also noted, as can be seen in FIG. 11, that without splitting aisles between pallet loads more pallets than not have case unit volumes below the maximum volume Vp of the respective pallet load, while in both the mixed mode clustered and adjacent aisles pallet load packages distribution method and the clustered aisle pallet load packages distribution method (with the exception of the last planned pallet load) have case unit volumes closer to the volume Vp allowed for a pallet load.

To increase the average pallet volume and reduce/minimize the number of pallets planned, while prioritizing contiguous/adjacent aisle planning (e.g. store-friendliness), splitting of the case units CU from some aisles is performed in the pallet planning. Here, the adjacent aisles pallet load packages distribution method may be “modified” to employ thresholds Vp0 and Vp1 where:

$$\text{Vp0 < Vp1 < Vp}$$

The values of Vp0 and Vp1 optimize the combination of pallet volumes (and minimize the number of pallets) and the number of split aisles. The values for Vp0 and Vp1 should be reasonably close to Vp, for example:

$$\text{Vp0 =} \text{.95} ∗ \text{Vp}$$

and

$$\text{Vp1 =} \text{.98} ∗ \text{Vp}$$

The values of Vp0 and Vp1 are generally held constant (e.g., not changed during the pallet planning iteration loops described herein), but may be adjusted for particular order profiles. For example, very large case units may warrant a reduction in Vp0 and Vp1 because it is more likely that some case units will not fit in a given pallet load, while small cases may warrant an increase in Vp0 and Vp1 as it is more likely that the case units will fit in a given pallet load.

In the adjacent aisles pallet load packages distribution method orders are placed by the order store 200 and the at least one store order affinity characteristic is determined in the manner described above with respect to FIG. 12B, Blocks 1200 and 1210. As described above, aisles having a volume greater than the predetermined volume Vp of a pallet load (or a weight greater than the maximum weight Wmax of a pallet load) are selected and assigned to a full/whole pallet. The number of pallets Np0 for the order is determined (FIG. 15, Block 1500) by the pallet load generator 165, 165′ based on the remaining case unit volume Vrem and weight Wrem and the expected product volume Vp and maximum weight Wmax in one pallet load according to the following equation:

$$N p 0 = m a x \left(c e i l \left(\frac{V r e m}{V p}\right) , c e i l \left(\frac{W r e m}{W m a x}\right)\right)$$

The pallet load generator 165, 165′ relates the aisles with each other (FIG. 12B, Block 1220, which in this example is a sequential aisle relationship) and determined aisle combinations that resolve a case unit arrangement in a pallet load (FIG. 12B, Block 1230). For example, the pallet load generator 165, 165′ determines aisle combinations for the “next” pallet load (FIG. 15, Block 1505, where the “next” pallet load is the pallet load currently being planned). Here, the aisles are selected sequentially (e.g., i, i+1, i+2 ...) and for each added aisle (FIG. 15, Block 1510) the cumulative case unit volume Vcomb and the cumulative pallet weight Wcomb are updated (FIG. 15, Block 1515). Where, the cumulative volume Vcomb is less than or equal to Vp0 and cumulative weight Wcomb is less than or equal to Wmax (FIG. 15, Block 1520), a next aisle in the sequence of aisles is added to the aisle combination (FIG. 15, Block 1510), effecting verification/confirmation of pallet-per-aisle ratio RPA optimization. Aisles are sequentially added to the aisle combination until one of the cumulative volume Vcomb exceeds the value Vp0 and the cumulative weight Wcomb exceeds the maximum pallet load weight Wmax.

Where one of the cumulative volume Vcomb exceeds the value Vp0 and the cumulative weight Wcomb exceeds the maximum pallet load weight Wmax, the remaining product volume Vrem and remaining product weight Wrem are updated (FIG. 15, Block 1530). An updated estimate for the number of pallets Np1 for the order is determined by the pallet load generator 165, 165′ in a manner similar to that described above, but using the updated values of Vrem and Wrem (i.e., the remaining volume and weight after the last aisle selected in Block 1510 of FIG. 15 of a first nested loop RL1 that includes blocks 1510, 1515, 1520 of FIG. 15, and that is nested within the overall/broader loop illustrated in blocks 1500-1580 and 1590 of FIG. 15) as follows:

$$N p 1 = m a x \left(c e i l \left(\frac{V r e m \left(u p a t e d\right)}{V p}\right) , c e i l \left(\frac{W r e m \left(u p d a t e d\right)}{W m a x}\right)\right)$$

Where the total number of pallets Np0 determined before the aisle selection for the next pallet load is the same as the updated number of pallets Np1 (i.e., Np0 = Np1+1, where the number 1 represents the current pallet) (FIG. 15, Block 1536), the selection of aisles for the next pallet load is stopped and a pallet load is planned (FIG. 15, Block 1565) from the aisle combination effecting optimization with respect to the minimum number of pallets.

Where the updated number of pallets Np1 increases (i.e., Np0 < Np1+1), additional aisles in the sequence of aisles are added to the aisle combination (FIG. 15, Block 1540) in a second nested loop RL2 that includes blocks 1540, 1545, 1550, 1555, 1560 of FIG. 15, and that is nested within the overall/broader loop illustrated in blocks 1500-1580 and 1590 of FIG. 15. With the next sequential aisle added to the aisle combination (FIG. 15, Block 1540), the cumulative case unit volume Vcomb and the cumulative pallet weight Wcomb are updated (FIG. 15, Block 1545). The remaining volume Vrem and the remaining weight Wrem of case units in the order is also updated (FIG. 15, Block 1550). An updated estimate for the number of pallets Np1(updated) for the order is determined (FIG. 15, Block 1555) by the pallet load generator 165, 165′ in the manner described above (see equation 8), but using the updated values of Vrem and Wrem determined in Block 1550 of FIG. 15. Here, if any one of the following conditions (equations 9-11) is not satisfied the recursive loop RL2 is repeated adding additional aisles to the aisle combination:

$$\text{Vcomb > Vp1}$$

$$\text{Wcomb > Wmax}$$

or

$$\text{Np0 = Np1} \left(\text{updated}\right) + 1$$

Where any one of the above conditions (equations 9-11) is satisfied the selection of aisles for the next pallet load is stopped and a pallet load is planned (FIG. 15, Block 1565) from the aisle combination, again effecting optimization with respect to the minimum number of pallets.

With the pallet load planned (FIG. 15, Block 1565), unplanned products from the aisle combination (e.g., a split aisle such as, e.g., aisle 6 which is split into case unit volumes V6A, V6B and aisle 12 which is split into case unit volumes V12A, V12B) are added, by the pallet load generator 165, 165′, to the remaining products in the order (FIG. 15, Block 1570). The pallet load generator 165, 165′ adds the planned pallet load (from FIG. 15, Block 1565) to an output list of pallet loads (FIG. 15, Block 1575) that effects the building of the pallet loads in the output list. The pallet load generator 165, 165′ determines if there are any remaining case units CU in the order (FIG. 15, Block 1580), again verifying/confirming optimization of the pallet-per-aisle ratio RPA. Where there are no more case units the pallet load planning for the order is stopped (FIG. 15, Block 1585) and the pallet loads PALOA, PALOA’ are built and shipped to the order store 200 in the manner described above with respect to FIG. 12B, Blocks 1240, 1250, and 1260. Where case units CU remain in the order the pallet count of the order is updated (FIG. 15, Block 1590) and another pallet is planned for the order in the manner described above, effecting a minimization of the number of pallets.

In the above adjacent aisles pallet load packages distribution method, making the volume of selected case units higher than the first threshold volume Vp0 may increase the probability that at least one aisle will not be fully packed into the pallet load currently being planned, such that a portion of the at least one aisle will overflow into the next subsequent pallet load that is planned. The overflow of case units from one pallet load to the next subsequent pallet load will raise the value of the pallet-per-aisle ratio RPA and, may lower the aisle adjacency (e.g., an overall store-friendliness of the ordered pallet loads). The values of Vp0 and Vp1 can be adjusted, as noted above, to reflect importance of minimizing the total number of pallets versus the pallet-per-aisle ratio RPA. Higher values (e.g., close to Vp) of both Vp0 and Vp1 may reduce the expected number of pallets, while lower values of both Vp0 and Vp1 may reduce the probability of splitting aisle between pallets (but may increase the expected number of pallets).

FIG. 11 illustrates a pallets loads, of an order, planned with the adjacent aisles pallet load packages distribution method described above. As noted above, the volumes illustrated in FIG. 11 are those same volumes corresponding to the aisles illustrated in FIG. 5. In accordance with the adjacent aisles pallet load packages distribution method a portion V2A of the volume V2 of aisle 2 consumes an entire/whole pallet load (e.g., pallet load 1) while the remaining volume V2B of aisle 2 considered for pallet planning in accordance with FIGS. 12 and 15 (as described above). It is noted that the volume V6 of aisle 6 is split between pallet loads 4 and 5 while the volume V12 of aisle 12 is split between pallet loads 6 and 7. The remaining volumes V1, V3, V4, V5, and V7-V11 for aisles 1, 3, 4, 5, and 7-11, and the remaining volume of aisle 2 are assigned to but one respective pallet load and each of the pallet loads has an uninterrupted sequence of aisles assigned to the pallet load. In this example, the total number of pallet loads is seven (as in FIG. 10 with the pallet loads thereof planned with a “pure” aisle adjacency, e.g., without employing the threshold values Vp0, Vp1 and the dual nested loops RL1, RL2); however, in FIG. 11 the last pallet load (pallet load 7), has a smaller volume compared to the last pallet load in FIG. 10, and may be placed on top of another pallet load in the order decreasing the amount of floor space required to transport the ordered pallet loads. It is noted that, generally, the “modified” adjacent aisles pallet load packages distribution method (that allow for splitting aisle case unit volumes between pallet loads) results in a smaller number of planned pallet loads than the “pure” adjacent aisles pallet load packages distribution method (that does not allow for splitting aisle case unit volumes between pallet loads).

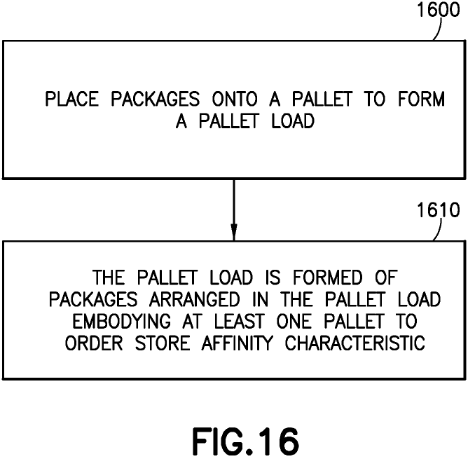

Referring now to FIGS. 1-4 and 16 a method for building a pallet load PALO, in accordance with any one or more of the clustered aisles pallet load packages distribution method, the mixed mode clustered and adjacent aisles pallet load packages distribution method, and the adjacent aisles pallet load packages distribution method, will be described. Here, packages are placed onto a pallet (see FIG. 1) to form a pallet load PALO (FIG. 16, Block 1600). Individual case units CU are provided from the storage array 130, as described herein, to the automated palletizer for forming the pallet load PALO, where the pallet load PALO includes more than one composite layers L1-Ln of case units CU. The pallet load PALO is formed of case units CU arranged in the pallet load PALO embodying at least one pallet to order store affinity characteristic 166, 166′ (FIG. 16, Block 1610) for a predetermined method of pallet load packages distribution at the order store 200. As described herein, the at least one pallet to order store affinity characteristic 166, 166′ is at least one for the clustered aisles pallet load packages distribution method, the mixed mode clustered and adjacent aisles pallet load packages distribution method, and the adjacent aisles pallet load packages distribution method at the order store.

In accordance with one or more aspects of the present disclosure, a material handling system for handling and placing packages onto pallets destined for an order store, the material handling system includes: a storage array with storage spaces for holding packages therein; an automated package transport system communicably connected to the storage array for storing packages within the storage spaces of the storage array and retrieving packages from the storage spaces of the storage array; an automated palletizer for placing packages onto a pallet to form a pallet load, the automated palletizer is communicably connected to the automated package transport system, the automated package transport system is configured to provide individual packages from the storage array to the automated palletizer for forming the pallet load, the pallet load including more than one composite layers of packages; and a controller operably connected to the automated palletizer, the controller being programmed with a pallet load generator with at least one pallet to order store affinity characteristic, for a predetermined method of pallet load packages distribution at the order store, the pallet load generator being configured so that the pallet load is formed by the automated palletizer of packages arranged in the pallet load embodying the at least one pallet to order store affinity characteristic.

In accordance with one or more aspects of the present disclosure, the at least one pallet to order store affinity characteristic is at least one for a clustered aisles pallet load packages distribution method, a mixed mode clustered and adjacent aisles pallet load packages distribution method, and an adjacent aisles pallet load packages distribution method at the order store.

In accordance with one or more aspects of the present disclosure, the at least one pallet to order store affinity characteristic is informed by a repeating dual loop determination at least one loop of which relates order store aisles to each other.

In accordance with one or more aspects of the present disclosure, within determination of the at least one loop, order store aisles are related to each other by at least one of an aisle to aisle affinity characteristic and product group type to product group type affinity characteristic.

In accordance with one or more aspects of the present disclosure, the aisle to aisle affinity characteristic is a distance separating one order store aisle from another order store aisle, or a contiguity or an adjacency of one order store aisle to another order store aisle.

In accordance with one or more aspects of the present disclosure, the at least one pallet to order store affinity characteristic is informed by a repeating dual loop determination at least one loop of which determines available combinations of order store aisles resolving arrangement of packages in the pallet load.

In accordance with one or more aspects of the present disclosure, each of the available combinations of order store aisles is determined based on: a maximization of the pallet load, or a combined maximization of the pallet load and a contiguity or adjacency of aisles in the available combination, wherein the maximization of pallet load is weighted higher than the contiguity or adjacency of aisles.

In accordance with one or more aspects of the present disclosure, each of the available combinations of order store aisles is determined based more on a contiguity or adjacency of order store aisles in an available combination and less on a maximization of the pallet load.

In accordance with one or more aspects of the present disclosure, the pallet load generator resolves the pallet load in accordance with the at least one pallet to order store affinity characteristic so that the pallet load is maximized with respect to at least one of a maximum pallet load volume and a maximum pallet load weight.

In accordance with one or more aspects of the present disclosure, the pallet load generator resolves the pallet load in accordance with the at least one pallet to order store affinity characteristic so that the pallet load has a maximum number of packages from a minimum number of order store aisles.

In accordance with one or more aspects of the present disclosure, the pallet load generator resolves the pallet load in accordance with the at least one pallet to order store affinity characteristic so as to generate a minimum number of pallet loads for each order store.

In accordance with one or more aspects of the present disclosure, the pallet load generator resolves the pallet load in accordance with the at least one pallet to order store affinity characteristic so that, for each pallet load destined for the order store, the packages forming the pallet load represent a minimum number of order store aisles.

In accordance with one or more aspects of the present disclosure, the pallet load generator resolves the pallet load in accordance with the at least one pallet to order store affinity characteristic so that, for each pallet load destined for the order store, the resolved pallet load represents a minimum number of order store aisles.

In accordance with one or more aspects of the present disclosure, the pallet load generator is configured so as to resolve each pallet load sequentially via a repeating dual loop determination informing the at least one pallet to order store affinity characteristic.

In accordance with one or more aspects of the present disclosure, the at least one pallet to order store affinity characteristic is informed by a dual nested loop determination at least one loop of which relates order store aisles to each other or determines available combinations of order store aisles resolving arrangement of packages in the pallet load.

In accordance with one or more aspects of the present disclosure, an automated palletizer includes: an automated package pick device capable of moving packages from a package deposit section to a pallet to form a pallet load from the packages, the pallet load including more than one composite layers of packages; and a controller operably connected to the automated palletizer, the controller being programmed with a pallet load generator with at least one pallet to order store affinity characteristic, for a predetermined method of pallet load packages distribution at the order store, the pallet load generator being configured so that the pallet load is formed by the automated palletizer of packages arranged in the pallet load embodying the at least one pallet to order store affinity characteristic.

In accordance with one or more aspects of the present disclosure, the at least one pallet to order store affinity characteristic is at least one for a clustered aisles pallet load packages distribution method, a mixed mode clustered and adjacent aisles pallet load packages distribution method, and an adjacent aisles pallet load packages distribution method at the order store.

In accordance with one or more aspects of the present disclosure, the at least one pallet to order store affinity characteristic is informed by a repeating dual loop determination at least one loop of which relates order store aisles to each other.

In accordance with one or more aspects of the present disclosure, within determination of the at least one loop, order store aisles are related to each other by at least one of an aisle to aisle affinity characteristic and product group type to product group type affinity characteristic.

In accordance with one or more aspects of the present disclosure, the aisle to aisle affinity characteristic is a distance separating one order store aisle from another order store aisle, or an contiguity or adjacency of one order store aisle to another order store aisle.

In accordance with one or more aspects of the present disclosure, the at least one pallet to order store affinity characteristic is informed by a repeating dual loop determination at least one loop of which determines available combinations of order store aisles resolving arrangement of packages in the pallet load.

In accordance with one or more aspects of the present disclosure, each of the available combinations of order store aisles is determined based on: a maximization of the pallet load, or a combined maximization of the pallet load and a contiguity or adjacency of aisles in the available combination, wherein the maximization of pallet load is weighted higher than the contiguity or adjacency of aisles.

In accordance with one or more aspects of the present disclosure, each of the available combinations of order store aisles is determined based more on a contiguity or adjacency of order store aisles in an available combination and less on a maximization of the pallet load.

In accordance with one or more aspects of the present disclosure, the pallet load generator resolves the pallet load in accordance with the at least one pallet to order store affinity characteristic so that the pallet load is maximized with respect to at least one of a maximum pallet load volume and a maximum pallet load weight.

In accordance with one or more aspects of the present disclosure, the pallet load generator resolves the pallet load in accordance with the at least one pallet to order store affinity characteristic so that the pallet load has a maximum number of packages from a minimum number of order store aisles.

In accordance with one or more aspects of the present disclosure, the pallet load generator resolves the pallet load in accordance with the at least one pallet to order store affinity characteristic so as to generate a minimum number of pallet loads for each order store.

In accordance with one or more aspects of the present disclosure, the pallet load generator resolves the pallet load in accordance with the at least one pallet to order store affinity characteristic so that, for each pallet load destined for the order store, the packages forming the pallet load represent a minimum number of order store aisles.

In accordance with one or more aspects of the present disclosure, the pallet load generator resolves the pallet load in accordance with the at least one pallet to order store affinity characteristic so that, for each pallet load destined for the order store, the resolved pallet load represents a minimum number of order store aisles.

In accordance with one or more aspects of the present disclosure, the pallet load generator is configured so as to resolve each pallet load sequentially via a repeating dual loop determination informing the at least one pallet to order store affinity characteristic.

In accordance with one or more aspects of the present disclosure, the at least one pallet to order store affinity characteristic is informed by a dual nested loop determination at least one loop of which relates order store aisles to each other or determines available combinations of order store aisles resolving arrangement of packages in the pallet load.

In accordance with one or more aspects of the present disclosure, a method for building a pallet load includes: placing packages onto a pallet to form a pallet load, where individual packages are provided from a storage array to form the pallet load, the pallet load including more than one composite layers of packages; and wherein the pallet load is formed of packages arranged in the pallet load embodying at least one pallet to order store affinity characteristic for a predetermined method of pallet load packages distribution at an order store.

In accordance with one or more aspects of the present disclosure, the at least one pallet to order store affinity characteristic is at least one for a clustered aisles pallet load packages distribution method, a mixed mode clustered and adjacent aisles pallet load packages distribution method, and an adjacent aisles pallet load packages distribution method at the order store.

In accordance with one or more aspects of the present disclosure, the at least one pallet to order store affinity characteristic is informed by a repeating dual loop determination at least one loop of which relates order store aisles to each other.

In accordance with one or more aspects of the present disclosure, within determination of the at least one loop, order store aisles are related to each other by at least one of an aisle to aisle affinity characteristic and product group type to product group type affinity characteristic.

In accordance with one or more aspects of the present disclosure, the aisle to aisle affinity characteristic is a distance separating one order store aisle from another order store aisle, or a contiguity or an adjacency of one order store aisle to another order store aisle.

In accordance with one or more aspects of the present disclosure, the at least one pallet to order store affinity characteristic is informed by a repeating dual loop determination at least one loop of which determines available combinations of order store aisles resolving arrangement of packages in the pallet load.

In accordance with one or more aspects of the present disclosure, each of the available combinations of order store aisles is determined based on: a maximization of the pallet load, or a combined maximization of the pallet load and a contiguity or adjacency of aisles in the available combination, wherein the maximization of pallet load is weighted higher than the contiguity or adjacency of aisles.

In accordance with one or more aspects of the present disclosure, each of the available combinations of order store aisles is determined based more on a contiguity or adjacency of order store aisles in an available combination and less on a maximization of the pallet load.

In accordance with one or more aspects of the present disclosure, the pallet load is resolved in accordance with the at least one pallet to order store affinity characteristic so that the pallet load is maximized with respect to at least one of a maximum pallet load volume and a maximum pallet load weight.

In accordance with one or more aspects of the present disclosure, the pallet load is resolved in accordance with the at least one pallet to order store affinity characteristic so that the pallet load has a maximum number of packages from a minimum number of order store aisles.

In accordance with one or more aspects of the present disclosure, the pallet load is resolved in accordance with the at least one pallet to order store affinity characteristic so as to generate a minimum number of pallet loads for each order store.

In accordance with one or more aspects of the present disclosure, the pallet load is resolved in accordance with the at least one pallet to order store affinity characteristic so that, for each pallet load destined for the order store, the packages forming the pallet load represent a minimum number of order store aisles.

In accordance with one or more aspects of the present disclosure, the pallet load is resolved in accordance with the at least one pallet to order store affinity characteristic so that, for each pallet load destined for the order store, the resolved pallet load represents a minimum number of order store aisles.

In accordance with one or more aspects of the present disclosure, each pallet load is resolved sequentially via a repeating dual loop determination informing the at least one pallet to order store affinity characteristic.

In accordance with one or more aspects of the present disclosure, the at least one pallet to order store affinity characteristic is informed by a dual nested loop determination at least one loop of which relates order store aisles to each other or determines available combinations of order store aisles resolving arrangement of packages in the pallet load.

In accordance with one or more aspects of the present disclosure, a pallet load includes: more than one composite layers of packages stacked on a pallet base; wherein the more than one composite layers of packages are formed of packages arranged in the pallet load embodying at least one pallet to order store affinity characteristic for a predetermined method of pallet load packages distribution at an order store.

In accordance with one or more aspects of the present disclosure, the at least one pallet to order store affinity characteristic is at least one for a clustered aisles pallet load packages distribution method, a mixed mode clustered and adjacent aisles pallet load packages distribution method, and an adjacent aisles pallet load packages distribution method at the order store.

In accordance with one or more aspects of the present disclosure, the at least one pallet to order store affinity characteristic is informed by a repeating dual loop determination at least one loop of which relates order store aisles to each other.

In accordance with one or more aspects of the present disclosure, within determination of the at least one loop, order store aisles are related to each other by at least one of an aisle to aisle affinity characteristic and product group type to product group type affinity characteristic.

In accordance with one or more aspects of the present disclosure, the aisle to aisle affinity characteristic is a distance separating one order store aisle from another order store aisle, or a contiguity or an adjacency of one order store aisle to another order store aisle.

In accordance with one or more aspects of the present disclosure, the at least one pallet to order store affinity characteristic is informed by a repeating dual loop determination at least one loop of which determines available combinations of order store aisles resolving arrangement of packages in the pallet load.

In accordance with one or more aspects of the present disclosure, each of the available combinations of order store aisles is determined based on: a maximization of the pallet load, or a combined maximization of the pallet load and a contiguity or adjacency of aisles in the available combination, wherein the maximization of pallet load is weighted higher than the contiguity or adjacency of aisles.

In accordance with one or more aspects of the present disclosure, each of the available combinations of order store aisles is determined based more on a contiguity or adjacency of order store aisles in an available combination and less on a maximization of the pallet load.

In accordance with one or more aspects of the present disclosure, the pallet load is resolved in accordance with the at least one pallet to order store affinity characteristic so that the pallet load is maximized with respect to at least one of a maximum pallet load volume and a maximum pallet load weight.

In accordance with one or more aspects of the present disclosure, the pallet load is resolved in accordance with the at least one pallet to order store affinity characteristic so that the pallet load has a maximum number of packages from a minimum number of order store aisles.

In accordance with one or more aspects of the present disclosure, the pallet load is resolved in accordance with the at least one pallet to order store affinity characteristic so as to generate a minimum number of pallet loads for each order store.

In accordance with one or more aspects of the present disclosure, the pallet load is resolved in accordance with the at least one pallet to order store affinity characteristic so that, for each pallet load destined for the order store, the packages forming the pallet load represent a minimum number of order store aisles.

In accordance with one or more aspects of the present disclosure, the pallet load is resolved in accordance with the at least one pallet to order store affinity characteristic so that, for each pallet load destined for the order store, the resolved pallet load represents a minimum number of order store aisles.

In accordance with one or more aspects of the present disclosure, each pallet load is resolved sequentially via a repeating dual loop determination informing the at least one pallet to order store affinity characteristicIn accordance with one or more aspects of the present disclosure, the at least one pallet to order store affinity characteristic is informed by a dual nested loop determination at least one loop of which relates order store aisles to each other or determines available combinations of order store aisles resolving arrangement of packages in the pallet load. It should be understood that the foregoing description is only illustrative of the aspects of the present disclosure. Various alternatives and modifications can be devised by those skilled in the art without departing from the aspects of the present disclosure. Accordingly, the aspects of the present disclosure are intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the aspects of the present disclosure.

What is claimed is:

1. A material handling system for handling and placing packages onto pallets destined for an order store, the material handling system comprising:
a storage array with storage spaces for holding packages therein;
an automated package transport system communicably connected to the storage array for storing packages within the storage spaces of the storage array and retrieving packages from the storage spaces of the storage array;
an automated palletizer for placing packages onto a pallet to form a pallet load, the automated palletizer is communicably connected to the automated package transport system, the automated package transport system is configured to provide individual packages from the storage array to the automated palletizer for forming the pallet load, the pallet load including more than one composite layers of packages; and
a controller operably connected to the automated palletizer, the controller being programmed with a pallet load generator with at least one pallet to order store affinity characteristic, for a predetermined method of pallet load packages distribution at the order store, the pallet load generator being configured so that the pallet load is formed by the automated palletizer of packages arranged in the pallet load embodying the at least one pallet to order store affinity characteristic.

2. The material handling system of claim 1, wherein the at least one pallet to order store affinity characteristic is at least one for a clustered aisles pallet load packages distribution method, a mixed mode clustered and adjacent aisles pallet load packages distribution method, and an adjacent aisles pallet load packages distribution method at the order store.

3. The material handling system of claim 1, wherein the at least one pallet to order store affinity characteristic is informed by a repeating dual loop determination at least one loop of which relates order store aisles to each other.

4. The material handling system of claim 1, wherein the at least one pallet to order store affinity characteristic is informed by a repeating dual loop determination at least one loop of which determines available combinations of order store aisles resolving arrangement of packages in the pallet load.

5. The material handling system of claim 1, wherein the pallet load generator resolves the pallet load in accordance with the at least one pallet to order store affinity characteristic so that the pallet load is maximized with respect to at least one of a maximum pallet load volume and a maximum pallet load weight.

6. The material handling system of claim 1, wherein the pallet load generator resolves the pallet load in accordance with the at least one pallet to order store affinity characteristic so that the pallet load has a maximum number of packages from a minimum number of order store aisles.

7. The material handling system of claim 1, wherein the pallet load generator resolves the pallet load in accordance with the at least one pallet to order store affinity characteristic so as to generate a minimum number of pallet loads for each order store.

8. The material handling system of claim 1, wherein the pallet load generator resolves the pallet load in accordance with the at least one pallet to order store affinity characteristic so that, for each pallet load destined for the order store, the packages forming the pallet load represent a minimum number of order store aisles.

9. The material handling system of claim 1, wherein the pallet load generator resolves the pallet load in accordance with the at least one pallet to order store affinity characteristic so that, for each pallet load destined for the order store, the resolved pallet load represents a minimum number of order store aisles.

10. The material handling system of claim 1, wherein the pallet load generator is configured so as to resolve each pallet load sequentially via a repeating dual loop determination informing the at least one pallet to order store affinity characteristic.

11. The material handling system of claim 1, wherein the at least one pallet to order store affinity characteristic is informed by a dual nested loop determination at least one loop of which relates order store aisles to each other or determines available combinations of order store aisles resolving arrangement of packages in the pallet load.

12. An automated palletizer comprising:
an automated package pick device capable of moving packages from a package deposit section to a pallet to form a pallet load from the packages, the pallet load including more than one composite layers of packages; and
a controller operably connected to the automated palletizer, the controller being programmed with a pallet load generator with at least one pallet to order store affinity characteristic, for a predetermined method of pallet load packages distribution at the order store, the pallet load generator being configured so that the pallet load is formed by the automated palletizer of packages arranged in the pallet load embodying the at least one pallet to order store affinity characteristic.

13. The automated palletizer of claim 12, wherein the at least one pallet to order store affinity characteristic is at least one for a clustered aisles pallet load packages distribution method, a mixed mode clustered and adjacent aisles pallet load packages distribution method, and an adjacent aisles pallet load packages distribution method at the order store.

14. The automated palletizer of claim 12, wherein the at least one pallet to order store affinity characteristic is informed by a repeating dual loop determination at least one loop of which relates order store aisles to each other.

15. The automated palletizer of claim 12, wherein the at least one pallet to order store affinity characteristic is informed by a repeating dual loop determination at least one loop of which determines available combinations of order store aisles resolving arrangement of packages in the pallet load.

16. The automated palletizer of claim 12, wherein the pallet load generator resolves the pallet load in accordance with the at least one pallet to order store affinity characteristic so that the pallet load is maximized with respect to at least one of a maximum pallet load volume and a maximum pallet load weight.

17. The automated palletizer of claim 12, wherein the pallet load generator resolves the pallet load in accordance with the at least one pallet to order store affinity characteristic so that the pallet load has a maximum number of packages from a minimum number of order store aisles.

18. The automated palletizer of claim 12, wherein the pallet load generator resolves the pallet load in accordance with the at least one pallet to order store affinity characteristic so as to generate a minimum number of pallet loads for each order store.

19. The automated palletizer of claim 12, wherein the pallet load generator resolves the pallet load in accordance with the at least one pallet to order store affinity characteristic so that, for each pallet load destined for the order store, the packages forming the pallet load represent a minimum number of order store aisles.

20. The automated palletizer of claim 12, wherein the pallet load generator resolves the pallet load in accordance with the at least one pallet to order store affinity characteristic so that, for each pallet load destined for the order store, the resolved pallet load represents a minimum number of order store aisles.

21. The automated palletizer of claim 12, wherein the pallet load generator is configured so as to resolve each pallet load sequentially via a repeating dual loop determination informing the at least one pallet to order store affinity characteristic.

22. The automated palletizer of claim 12, wherein the at least one pallet to order store affinity characteristic is informed by a dual nested loop determination at least one loop of which relates order store aisles to each other or determines available combinations of order store aisles resolving arrangement of packages in the pallet load.

23. A method for building a pallet load, the method comprising:
placing packages onto a pallet to form a pallet load, where individual packages are provided from a storage array to form the pallet load, the pallet load including more than one composite layers of packages; and
wherein the pallet load is formed of packages arranged in the pallet load embodying at least one pallet to order store affinity characteristic for a predetermined method of pallet load packages distribution at an order store.

24. The method of claim 23, wherein the at least one pallet to order store affinity characteristic is at least one for a clustered aisles pallet load packages distribution method, a mixed mode clustered and adjacent aisles pallet load packages distribution method, and an adjacent aisles pallet load packages distribution method at the order store.

25. The method of claim 23, wherein the at least one pallet to order store affinity characteristic is informed by a repeating dual loop determination at least one loop of which relates order store aisles to each other.

26. The method of claim 23, wherein the at least one pallet to order store affinity characteristic is informed by a repeating dual loop determination at least one loop of which determines available combinations of order store aisles resolving arrangement of packages in the pallet load.

27. The method of claim 23, wherein the pallet load is resolved in accordance with the at least one pallet to order store affinity characteristic so that the pallet load is maximized with respect to at least one of a maximum pallet load volume and a maximum pallet load weight.

28. The method of claim 23, wherein the pallet load is resolved in accordance with the at least one pallet to order store affinity characteristic so that the pallet load has a maximum number of packages from a minimum number of order store aisles.

29. The method of claim 23, wherein the pallet load is resolved in accordance with the at least one pallet to order store affinity characteristic so as to generate a minimum number of pallet loads for each order store.

30. The method of claim 23, wherein the pallet load is resolved in accordance with the at least one pallet to order store affinity characteristic so that, for each pallet load destined for the order store, the packages forming the pallet load represent a minimum number of order store aisles.

31. The method of claim 23, wherein the pallet load is resolved in accordance with the at least one pallet to order store affinity characteristic so that, for each pallet load destined for the order store, the resolved pallet load represents a minimum number of order store aisles.

32. The method of claim 23, wherein each pallet load is resolved sequentially via a repeating dual loop determination informing the at least one pallet to order store affinity characteristic.

33. The method of claim 23, wherein the at least one pallet to order store affinity characteristic is informed by a dual nested loop determination at least one loop of which relates order store aisles to each other or determines available combinations of order store aisles resolving arrangement of packages in the pallet load.
